(19) United States
(12) Patent Application Publication
(10) Pub. No.: US 2005/0045041 A1
(43) Pub. Date: Mar. 3, 2005

(54) Removable cartridge for swing-type adsorption system

(76) Inventors: Glenn R. Hechinger, Costa Mesa, CA (US); Robert A. Zarate, Murrieta, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/651,862

(22) Filed: Aug. 29, 2003

(51) Int. Cl. B01D 53/02

(52) U.S. Cl. 96/121

(57) ABSTRACT

A removable cartridge for the adsorbent bed of a swing-type adsorber system defines a volume for retaining an adsorbent material within an adsorption bed housing during operation of the adsorption system. Additionally, the cartridge is configured to retain the adsorbent material therein so that the cartridge and the adsorbent material can be removed and installed as a unit.

### BACKGROUND OF THE INVENTION

1. Field of the Invention

The present application is directed to adsorber systems, and in particular, to an improved adsorber bed that can be used with a pressure-swing adsorption system.

2. Description of the Related Art

The industrial and commercial uses of nitrogen, oxygen, and other purified fluids have created tremendous demands for such fluids in both liquid and gaseous phases. These demands are primarily met through large-scale stationary production facilities. Unfortunately, these facilities are located a substantial distance from the end user, necessitating the transportation of large quantities of liquid oxygen and nitrogen over substantial distances. For example, mobile medical facilities for emergency response bureaus require large mounts of liquid oxygen at remote locations. As liquid oxygen is highly explosive, and both liquid oxygen and liquid nitrogen must be kept under heavy pressure at extremely low temperatures, the transportation process is both dangerous and expensive.

Oxygen and nitrogen of high purity may be obtained through cryogenic distillation of ambient air. For effective distillation, the ambient air is filtered prior to the distillation process. In particular, H₂O, and CO₂ must be reduced to a concentration of less than 1 part per million (ppm) prior to the airstream entering the distillation columns. One such portable liquid oxygen/liquid nitrogen generating system is disclosed in the inventor's U.S. Pat. No. 4,957,523.

The process of adsorption is the assimilation of gas, vapor, or dissolved matter by the surface of a solid. Generally, adsorbers comprise an outer containment vessel with adsorbent material, or desiccant, distributed within, through which a fluid being filtered passes. There are many types of adsorbent material, including molecular sieves, activated alumna, silica gel, adsorbent clays, and activated carbon. Within each class of adsorbent there are hundreds of variations, both in chemical composition and granular form. The granular form includes such shapes as spherical beads, pellet extrudates, tablets, and irregular granules. While adsorbents used in industry are extremely rugged, they can be destroyed if either the internal or external stresses encountered in the service environment are excessive. Additionally, prolonged use eventually causes fatigue failures of the material itself or of immobilizing agents applied thereto.

Currently, there are two general classes of adsorber systems: temperature-swing adsorbers (TSAs) and pressure-swing adsorbers (PSAs). Both types of adsorbers have two stages of operation: one in which certain contaminates are adsorbed and thus removed from the fluid and the other in which the adsorber is purged of the contaminants which have adsorbed into the adsorbent material. TSA adsorbers have a filtering stage at around 40° F. and must be purged at relatively high temperatures (around 500° F.). TSA adsorbers typically require at least three hours to change from filtration temperature to regeneration temperature, to complete the regeneration and to change back to process temperature (one regeneration cycle). This regeneration cycle achieves a high level of contamination of the filtration bed during the filtering stage.

Pressure swing adsorbers, on the other hand, operate at a relatively constant temperature, but filtering at a high pressure and purging at a low pressure. Rapid PSAs have been developed with regeneration cycles of between 30 and 90 seconds. Such rapid pressure-swings, however, can send shock waves through adsorbent material, thereby accelerating fluidization, abrasion and/or fracture of the adsorbent material.

Immobilized adsorbent material provides enhanced resistance to fluidization or abrasion of adsorbent beads or grains. Such immobilization can be achieved by coating and bonding the beads or grains with an immobilizing agent. Known immobilization requires that the beads or grains be coated and bonded in-situ within an adsorber bed housing. Thus, if the adsorbent material becomes overly contaminated or the immobilizing agent has fractured, the entire adsorber bed must be replaced.

The inventor's U.S. Pat. No. 4,957,523 discloses the use of a dual-bed, immobilized, rapid PSA unit. The PSA includes two immobilized molecular sieve-type, bonded regenerable packed cylindrical beds. When one of the beds is on-line, processing the inlet airstream, the second bed is off-line being purged and regenerated. The regeneration of the off-line bed allows the invention to operate continuously without shutting down during periods of bed regeneration. Typically, one bed is online for 95 seconds, while the flow stream is filtered. During this 95 seconds the second bed is first depressurized, or dumped, then purged, and then pressurized in preparation for going on-line again. The stresses generated on the adsorbent material because of the rapid pressure-swings necessitate the use of immobilized beds.

For processes with two adsorber beds to be continuous, one adsorber bed must be depressurized from the on-stream pressure to the purge pressure, purged of the impurities, and repressurized to the on-stream pressure during the period of time that the other adsorber bed is purifying or separating the feed gas for the process. The “feed gas” is the unfiltered airstream entering the adsorption units. As a general rule of thumb, for the off-stream adsorber bed to be adequately purged, the purge gas must be of a volume at least equal to the volume of feed gas that passes through the adsorber bed, and preferably more than 1.5 times the feed gas on-stream volume. For example, if 100 cubic feet of feed gas were purified during the on-stream period, 100 cubic feet or more of purge gas must pass through the adsorber bed during the off-stream purging period. The gas used for purging the off-stream adsorber bed is usually a portion of the purified gas exiting the on-stream adsorber bed. Since the gas exiting the on-stream adsorber bed is used for the process, the net yield of purified gas is reduced by the amount required for purging the off-stream adsorber bed. With cryogenic air separation processes, sufficient waste gas must be available for purging the off-stream adsorber bed, or additional purge gas must be extracted from the purified air exiting the on-stream adsorber bed. This can make the cryogenic air separation process less efficient than it would have been had the purging gas requirement not been considered.

The time required to depressurize and repressurize the adsorber beds is the function of the on-stream and purge pressures, the volume of the adsorber beds, and the rates of flow into and out of the adsorber beds. If pressurizing and depressurizing occurs too rapidly, the desiccant material may be damaged due to fluidizing or abrasion, with subsequent loss of desiccant and/or fracturing of the desiccant due to the rapid reduction of the pressure on the exterior surfaces of the desiccant before the pressure in the interior of the desiccant is reduced. The time required for depressurizing and repressurizing without damaging the desiccant is usually optimized based upon the physical size of the adsorber beds, and is thus fixed.

For a more portable system, for example if it is desired to shorten the on-stream time so the size of the adsorber beds can be reduced, the off-stream time must also be shortened to match. Since the depressurizing and repressurizing times are fixed, the time shortening period must come from the purging period. Since the purging time must be shortened a disproportionately greater amount than the on-stream time, the purging gas flow rate must be increased in order to maintain an adequate purge gas volume. This results in even less of the purified gas being available for the end process.

There has been a need for a more compact and efficient rapid PSA system utilizing nonimmobilized desiccant material within the adsorber beds.

### SUMMARY OF THE INVENTION

One aspect of at least one of the inventions disclosed herein includes the realization that a substantial time saving can be achieved by constructing the adsorbent beds of the pressure-swing system with a removable cartridge containing the adsorbent materials. For example, certain high speed pressure-swing adsorption systems include adsorbent beds formed of a molecular sieve bed having immobilized beads. For example, but without limitation, such molecular sieves can include beads for filtering certain gasses from air. Such molecular sieve type beads can be coated and thus bonded to each other by a process that is owned by Pall Safety Atmospheres, Inc. This coating bonds together the beads at a point of contact there between but does not cover the remaining outer surface of the beads so as to avoid interfering with the adsorption process. However, over time and repeated pressure changes to which the adsorber beds are subjected, the bonds between the beads can be broken. As such, through continued use of the pressure-swing system and the associated pressure changes and fluid flow direction changes, the beads abraid against each other. As such, the beads begin to wear down and thus release small particles and dust into the pressure-swing adsorber system. Such dust can contaminate the system and clog other downstream filters. Thus, the beads are replaced from time to time.

In order to open an inner chamber of an adsorber bed assembly for removal and re-installation of adsorber beads, numerous pipes and high torque fittings must be disassembled. Additionally, after used beads have been removed from the adsorber assembly, new beads must be installed and properly encased within the housing. As such, the replacement of such beads can not typically be performed by a user of the equipment. Thus, a specially trained service person must personally perform the repair on site. Such repairs can take a week to perform.

However, as noted above, it has been realized that the complexity of and the required time for replacing the beads of an adsorption bed can be greatly reduced while providing a higher quality and longer lasting replacement product by providing the adsorber bed housing with a removable cartridge configured to encapsulate the beads under pressure.

Thus, accordingly, a pressure swing absorber unit can comprise a housing defining an interior chamber. A removable cartridge assembly can be removably disposed in the interior chamber. The removable cartridge assembly preferably comprises a wall assembly defining an absorber chamber, inlet and outlet screen members, and an absorber material disposed in the wall assembly. The inlet and outlet screen members are configured to retain the absorber material within the absorber chamber.

In accordance with another aspect of at least one of the inventions disclosed herein, a removable adsorbent bed cartridge for a swing type adsorber system includes a wall assembly defining an open inlet and an open outlet. A plurality of adsorbent members can be disposed in the wall assembly. A first perforated member can be disposed at the inlet end and a second perforated member can be disposed at the outlet end. The first and second perforated members being configured to retain the adsorbent members therein. The wall assembly is configured to be received within a housing of an adsorber bed assembly of the swing type adsorber system.

In accordance with yet another aspect of at least one of the inventions disclosed herein, a removable adsorbent bed cartridge for a swing type adsorber system comprises a wall assembly defining an open inlet and an open outlet. A plurality of adsorbent are members disposed in the wall assembly. A first perforated member is disposed at the inlet end and a second perforated member is disposed at the outlet end. The first and second perforated members are configured to retain the adsorbent members therein. The cartridge also includes means for forming a seal between an outer surface of the wall assembly and an inner surface of a housing of an adsorber bed assembly of the swing type adsorber system.

### BRIEF DESCRIPTION OF THE DRAWINGS

FIG. 1 is a diagram illustrating a cryogenic air separation system utilizing a three-bed, pressure-swing adsorber unit which can incorporate immobilized or nonimmobilized adsorbent material, which illustrates one exemplary environment of use for the present adsorber bed assembly;

FIGS. 2a-2m schematically illustrate the adsorber unit of FIG. 1 in various stages of operation;

FIG. 3 schematically illustrates the adsorber unit of FIGS. 2a-2m and a microprocessor control system;

FIG. 4 is a table illustrating the conditions of a number of control valves for discrete steps in the cycle of operation of the adsorber unit;

FIG. 5 is a table illustrating the conditions of each of the three adsorber beds at the times corresponding to FIGS. 2a-2m;

FIG. 6 is a front elevational view of an exemplary three bed adsorber unit with the cryogenic air separation system illustrated in FIG. 1;

FIG. 7 is a top plan view of the three-bed adsorber unit of FIG. 6;

FIG. 8 is a side elevational view of the three-bed adsorber unit of FIG. 6;

FIG. 9 is a top plan view of one of the adsorber beds illustrated in FIG. 6, with certain pipes removed;

FIG. 10 is a cross sectional view of the adsorber bed assembly illustrated in FIG. 9, viewed along section line 10-10;

FIG. 11 is a sectional view of the adsorber bed illustrated in FIG. 10, viewed along section line 11-11 and illustrating a plurality of loading assemblies;

FIG. 11A is a sectional view of a portion of one of the loading assemblies illustrated in FIG. 11;

FIG. 12 is a top plan view of an adsorber bed constructed in accordance with at least one of the inventions disclosed herein;

FIG. 13 is a sectional view of the adsorber bed illustrated in FIG. 12, as viewed along section line 13-13;

FIG. 14 is a sectional view of the adsorber bed illustrated in FIG. 13, as viewed along section line 14-14;

FIG. 15 is a partial sectional and side elevational view of a removable adsorber bed cartridge removed from the housing of FIGS. 12-14;

FIG. 16 is a top plan view of the cartridge illustrated in FIG. 15, as viewed along line 16-16.

### DETAILED DESCRIPTION OF THE PREFERRED EMBODIMENT

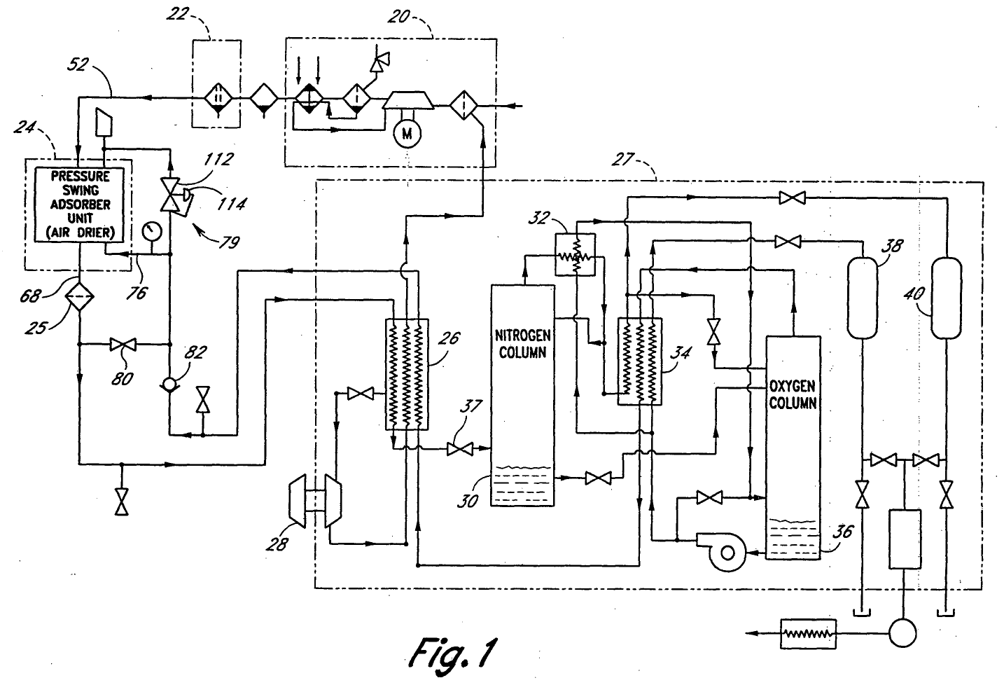

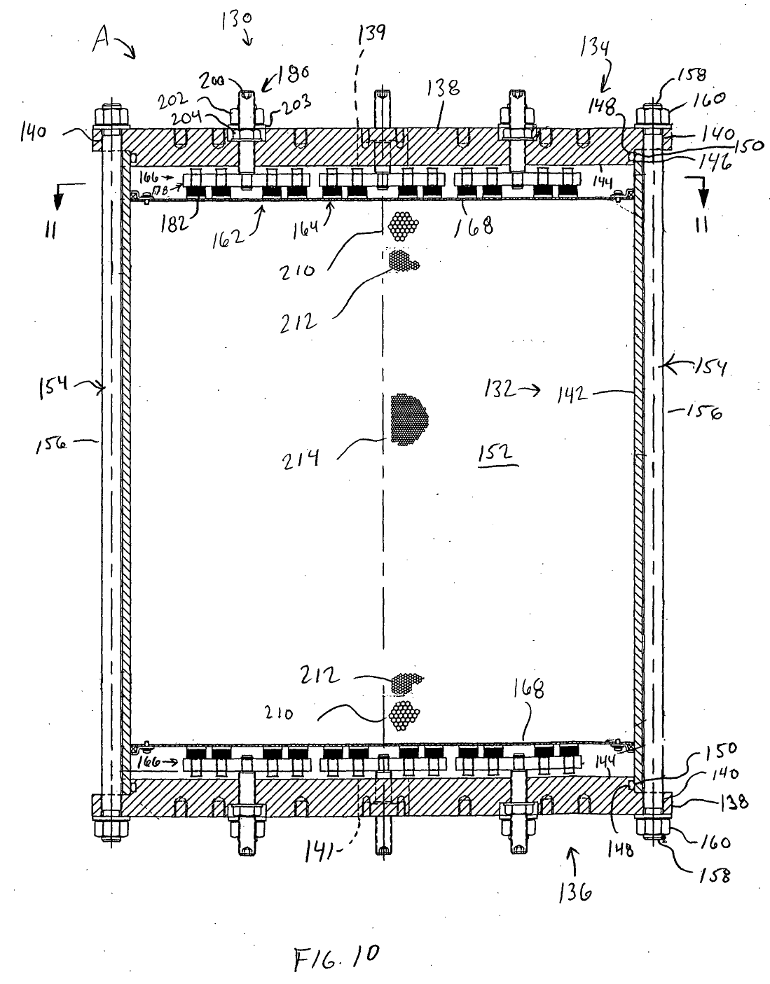

FIGS. 1-11 illustrate one environment of use in which the present adsorber bed assembly can be used. In particular, FIG. 1 illustrates a liquid oxygen/nitrogen generating system comprising an air compressor assembly 20, a coalescer/HEPA filter 22, a pressure-swing adsorber (PSA) 24, a heat exchanger 26, a turbo expander 28, a nitrogen distillation column 30, a condenser 32, a subcooler 34, and an oxygen distillation column 36. However, the present adsorber bed assembly can be used with any type of system which benefits from periodic replacement of a sieve, filter, absorbent or adsorbent material.

In operation, prefiltered air is pressurized within the air compressor 20, and the air is sent through the HEPA filter 22 to remove most of the oil and water aerosols left over from the compression process. The compressed air is then fed into the PSA unit 24 where chemical impurities, H₂O, and CO₂ vapor are removed to a concentration of less than 1 ppm. In addition, the PSA 24 removes common pollutants found in the atmosphere, such as carbon monoxide, methane, ethane, nitrous oxides, and oil vapors. The dried, purified inlet airstream passes through a filter 25 to remove any particulate matter produced by the PSA 24.

After the PSA 24 and filtering, the airstream flows to the cryogenic distillation process, which, along with the storage tanks 38 and 40, is generally encompassed by the dashed outline 27. The airstream first enters the heat exchanger 26, which cools the inlet air to cryogenic temperatures, partially liquefying the airstream. Approximately 75% of the inlet airstream is diverted from the heat exchanger 26 through the turbo expander 28 where it experiences a pressure loss from approximately 150 psig to 2 psig. The expansion of the air creates a cryogenic air flow which is employed to cool the remaining inlet airstream in the heat exchanger 26. The remaining 25% of the inlet airstream then passes through an air expansion valve 37 which allows a reduction of the inlet airstream pressure to approximately 85 psig, further reducing the temperature of the airstream. The partially liquified cryogenic inlet airstream from the expansion valve 37 enters the dual distilling columns 30, 36 which separate and liquefy the nitrogen and oxygen components within the airstream.

The resulting liquid is fed into two storage tanks 38, 40 for the oxygen and nitrogen, respectively. Because the storage tanks 38, 40 are desirably at a lower pressure than the corresponding distilling column 30, 36, the liquid oxygen and nitrogen must be subcooled in the subcooler 34 to remain in liquid phase. The subcooler 34 thereby cools the liquid oxygen and nitrogen below their condensing temperatures, which allows for transfer of the fluids to their respective storage tanks 38, 40 without incurring vaporization of the liquids.

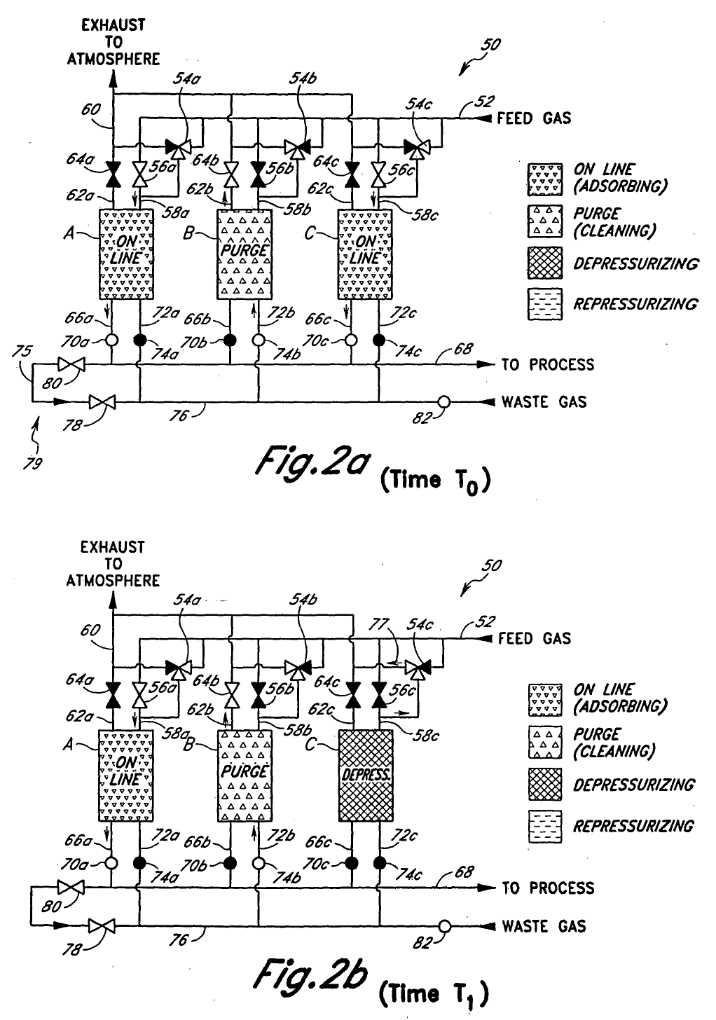

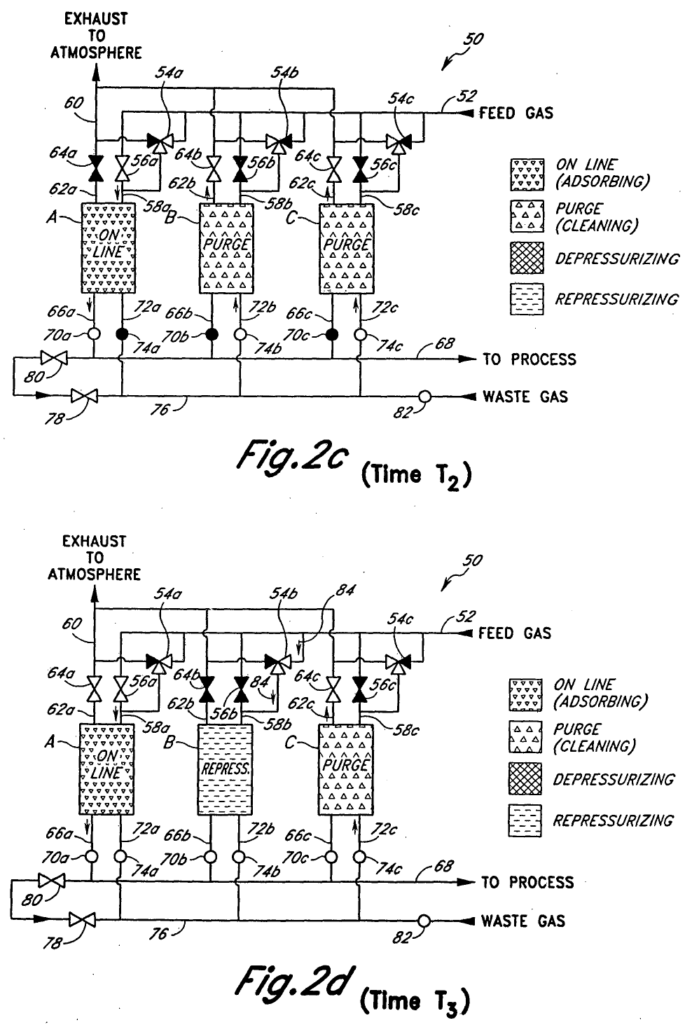

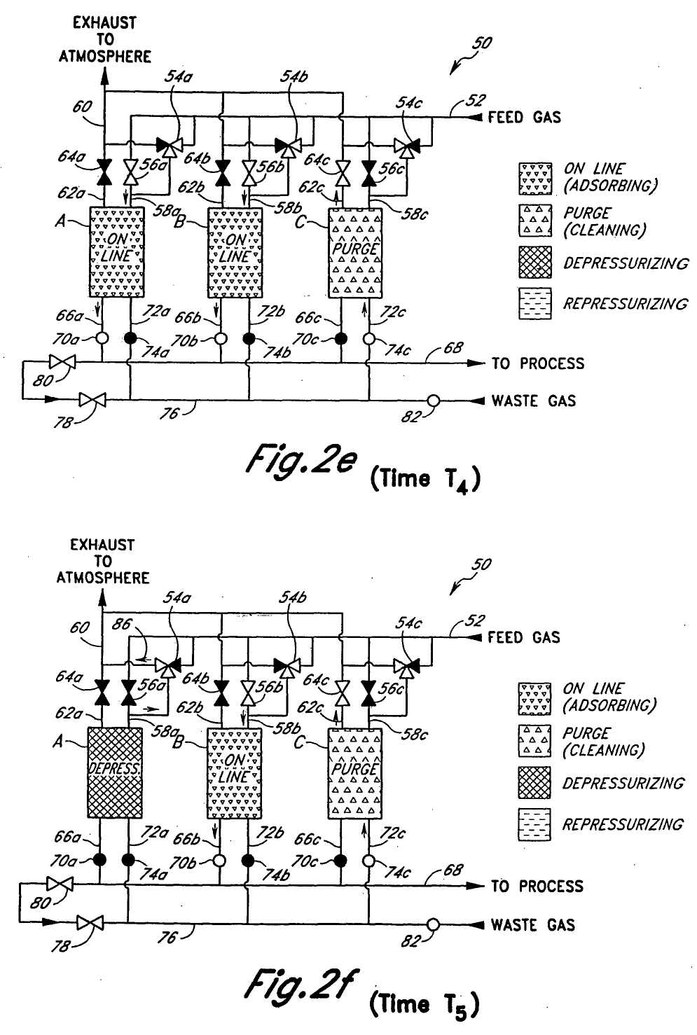

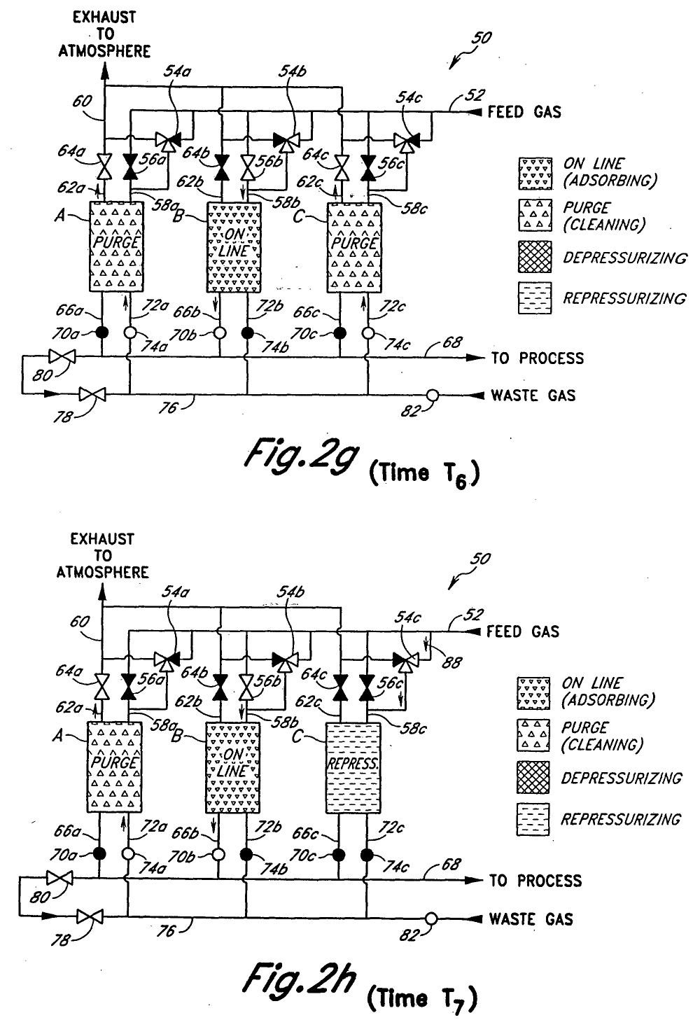

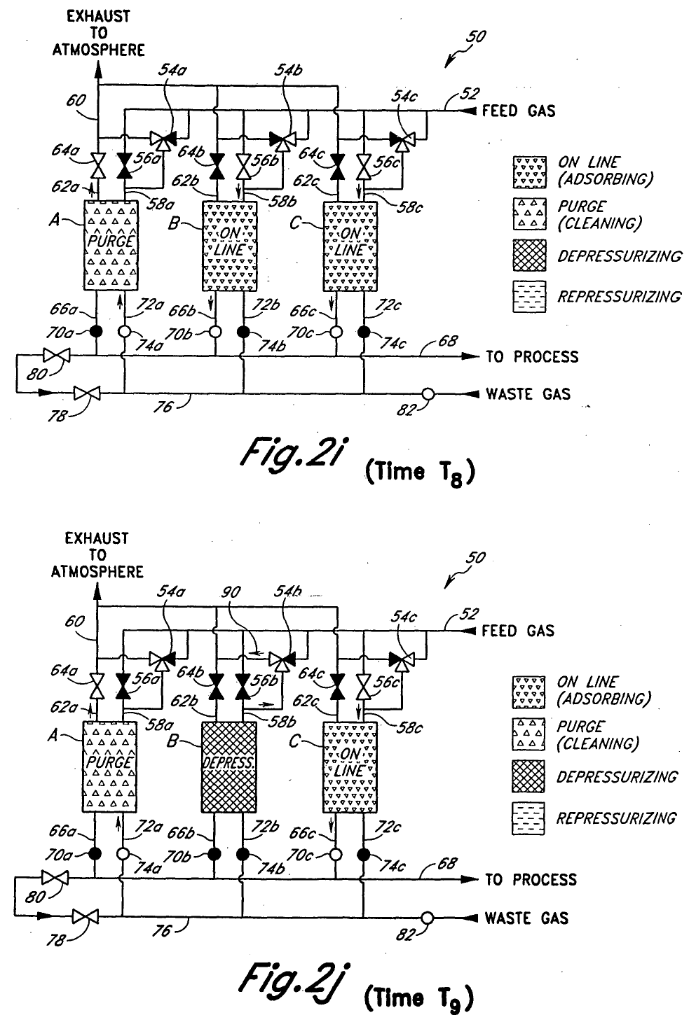

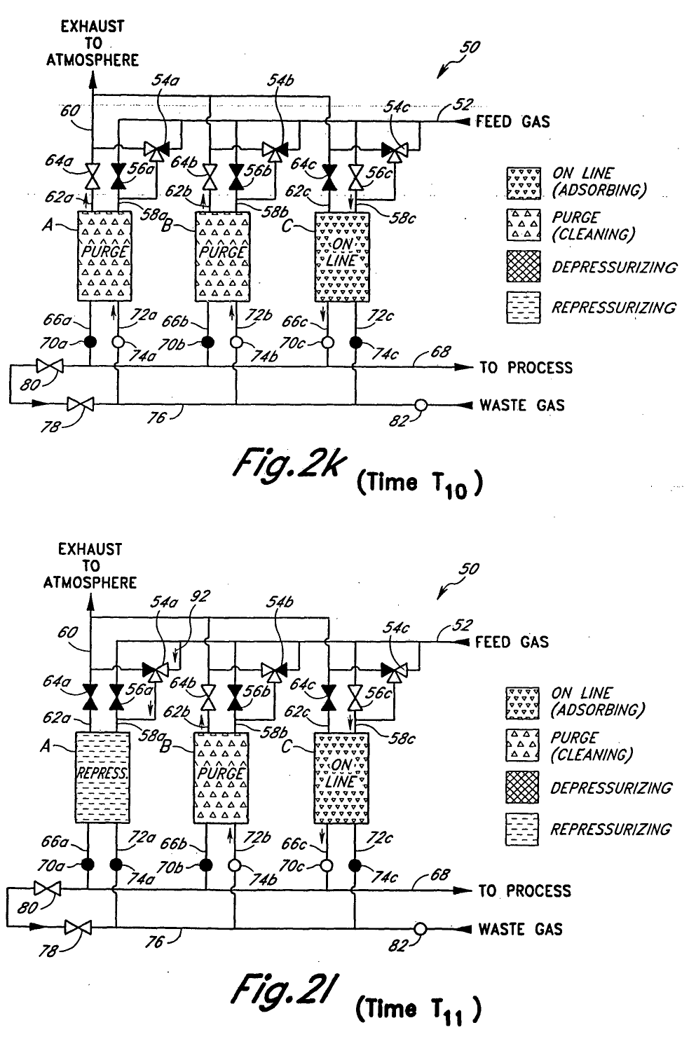

With specific reference to FIGS. 2a-2m, a three-bed, nonimmobilized PSA system 50 is shown. The system 50 comprises three parallel adsorber beds, denoted A, B, and C. Each bed A, B, or C comprises an outer containment vessel and is closely packed with a desiccant which can be of the immobilized or nonimmobilized type. A feed gas line 52 communicates with each bed A, B, C through input legs of three-way valves 54a, 54b, 54c, and through selectable valves 56a, 56b, 56c. The three-way valves 54 and selectable valves 56 join at a common input line 58 into each bed. It will be noted that the valves and input and output lines to each of the adsorber beds A, B, C, can be identical, and thus the description herein may at times refer to individual valves or lines, and at other times may generically refer to any one of the three valves or lines using the element number alone, without alphabetic designation.

Each of the three-way valves 54 includes an output leg in communication with an exhaust line 60 common to all three adsorber beds. Each of the adsorber beds has an exhaust outlet 62 in communication with the exhaust line 60 through a valve 64. On the other end of each of the adsorber beds, shown in the lower portion of FIGS. 2a-2m, an adsorber bed output line 66 leads to a cryogenic distillation process input line 68. Each one of the adsorber beds has a check valve 70 positioned in the output line 66. A purge inlet line 72 for each of the adsorber beds also includes a check valve 74 between the adsorber bed and a waste gas line 76.

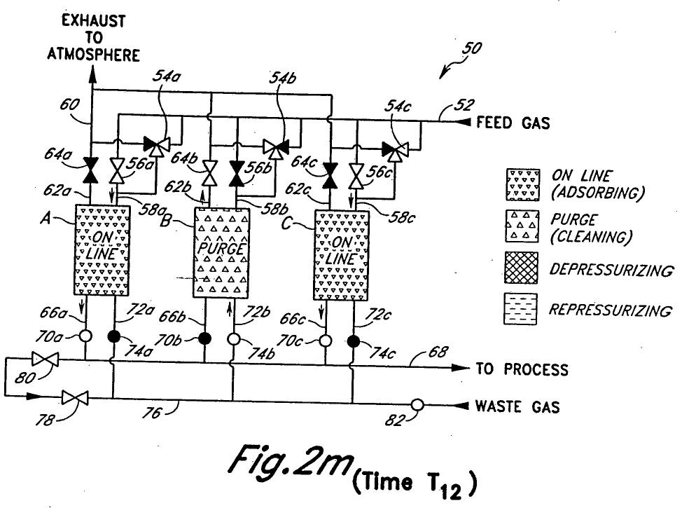

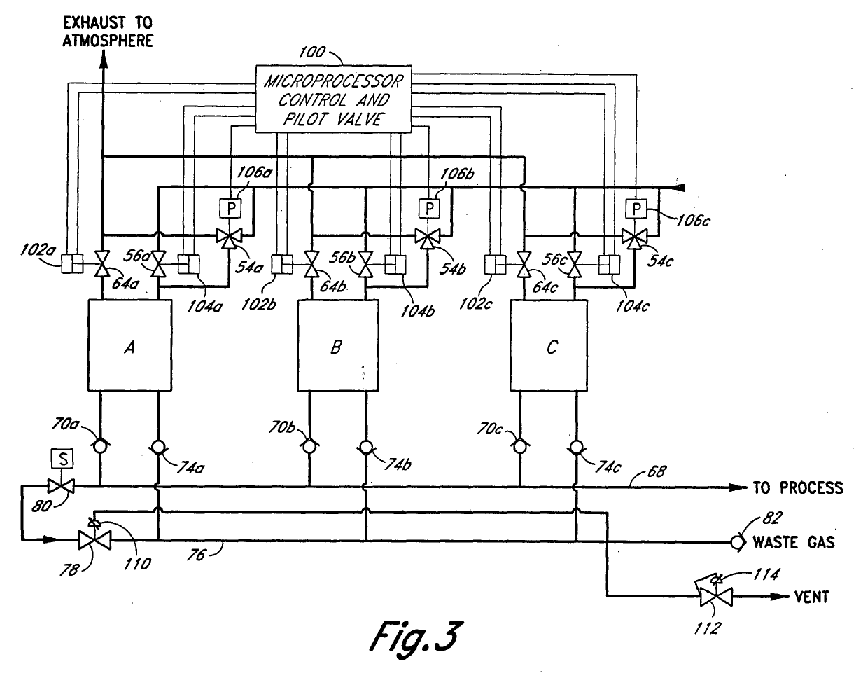

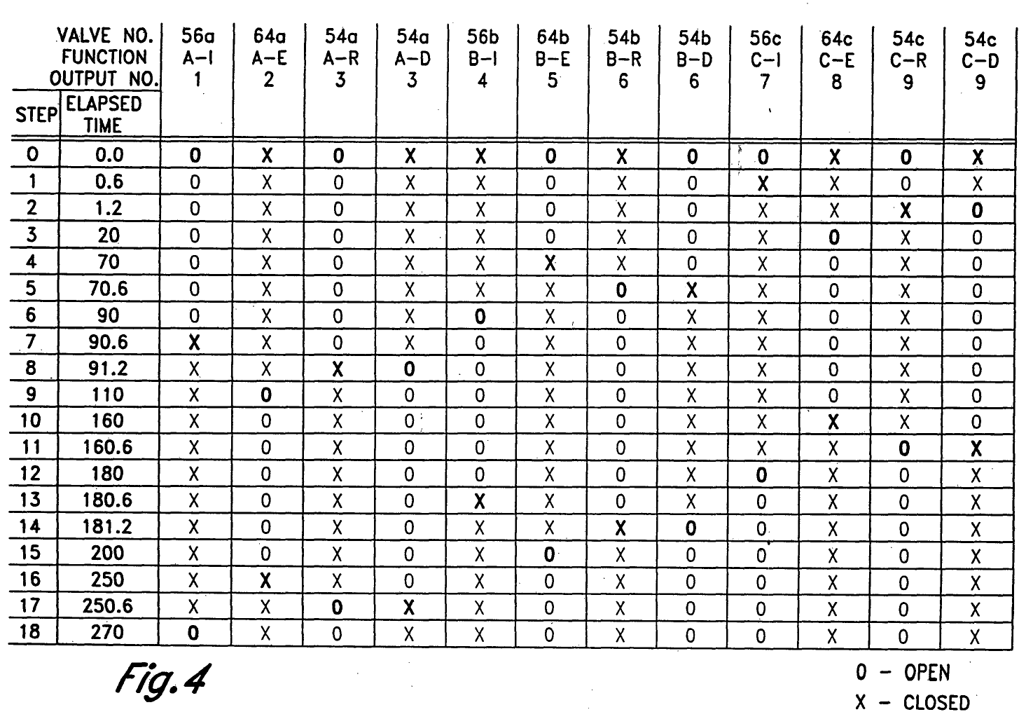

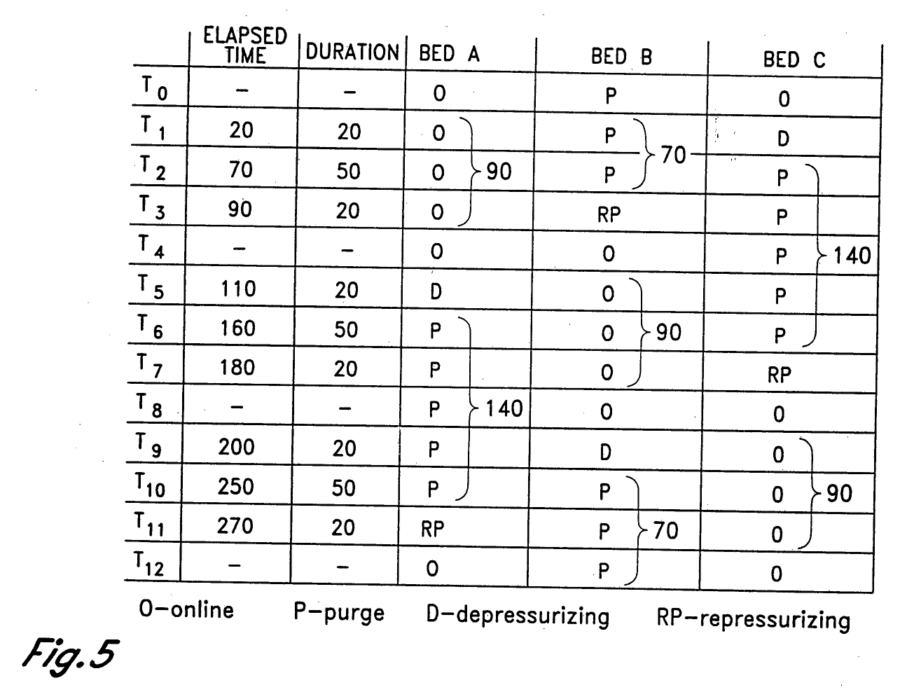

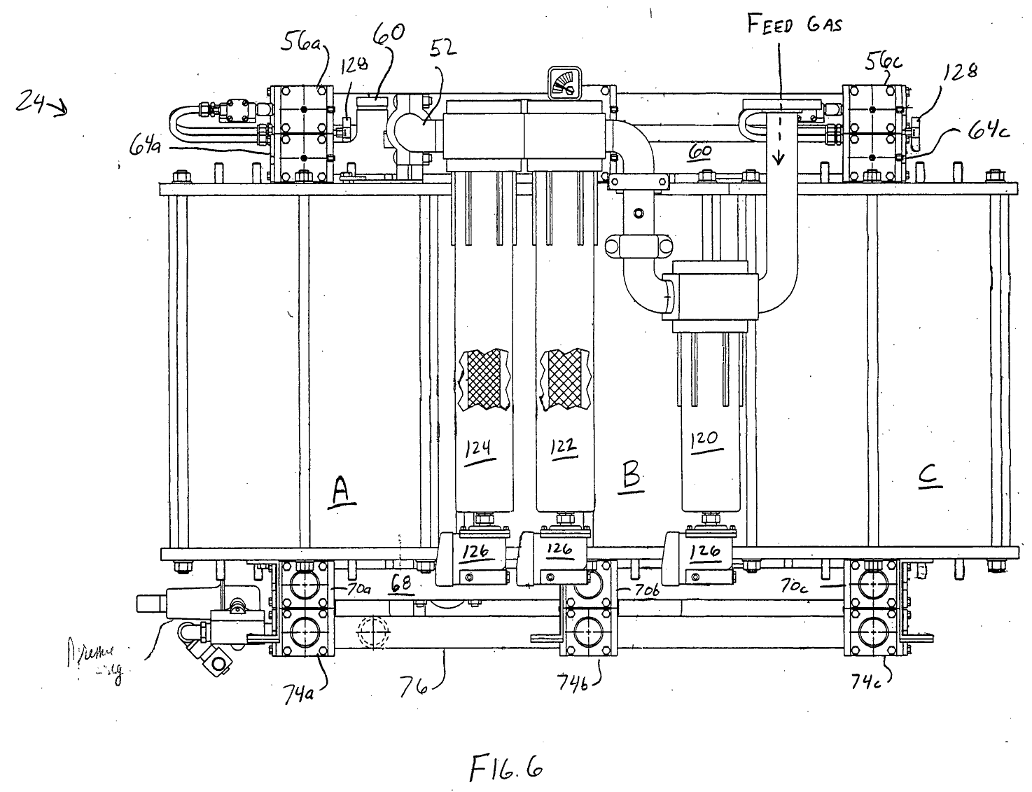

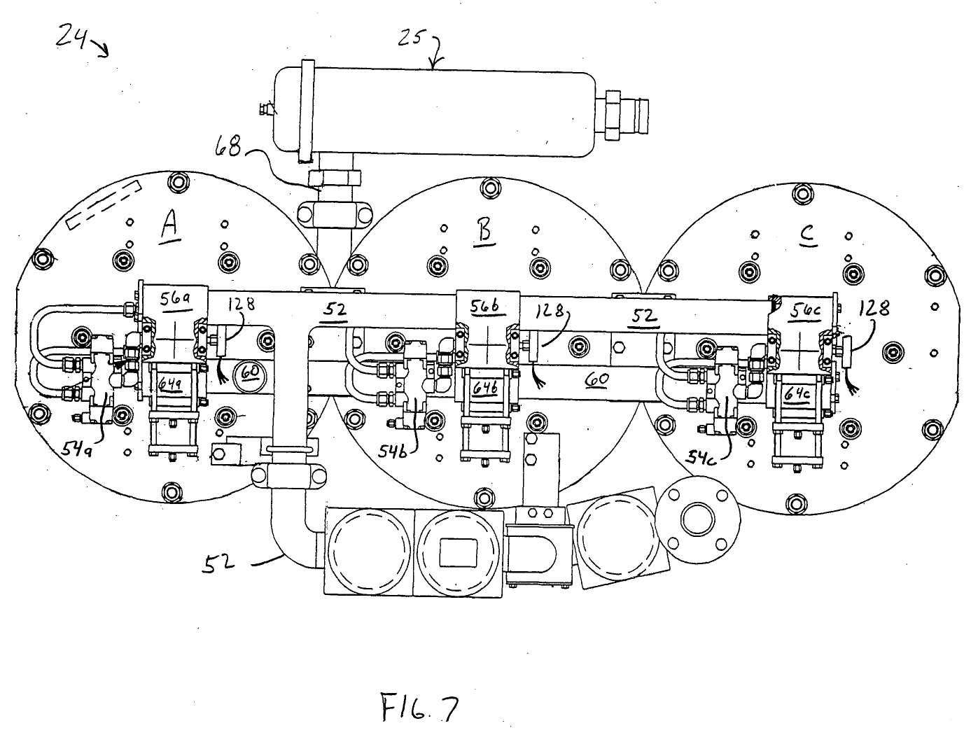

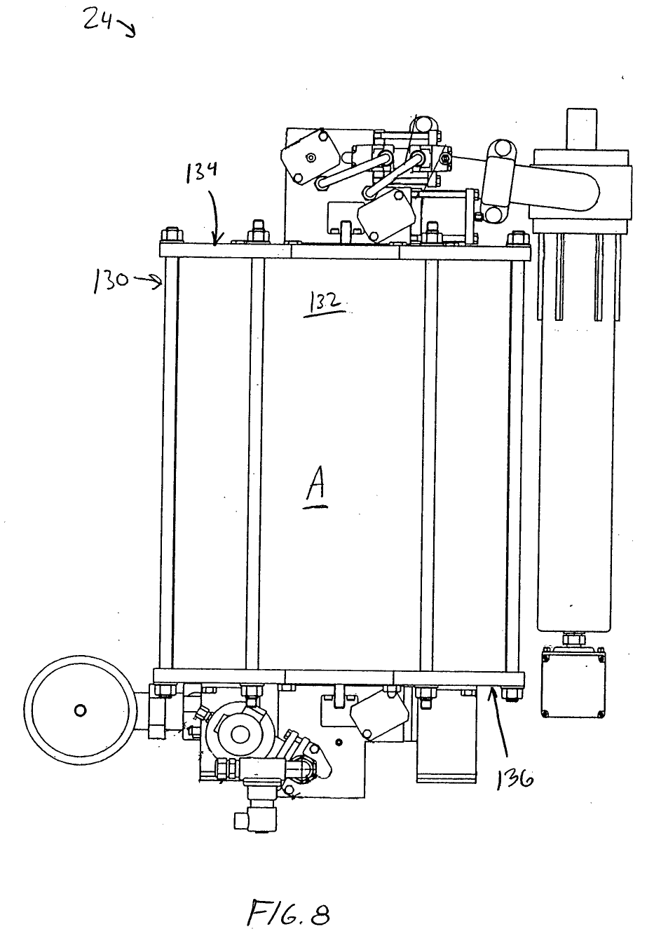

As described below with reference to FIGS. 3 and 4, the valves 54, 56, 64, 70 and 74 are configured for controlling the states of operation of the three-bed PSA unit 50. The operational state of each valve is indicated by the valve being either shown in outline to designate open, or shown blackened to designate closed. The selectable valves 56 and 64 are preferably poppet-type valves wherein the poppet position is determined by an air-operated double-acting piston. Air pressure apply to sides of the piston is controlled by a solenoid (102 and 104, respectively, shown in FIG. 3). Likewise, the operational state of the three-way valves 54 is indicated by the blackened portions of the upper left (output) or right (input) leg for each valve. The valves 56 and 64 are either open or closed allowing or preventing flow through each respective line. The three-way valves 54 are essentially toggle switches alternately permitting the flow of input feed gas into the respective adsorber bed, or the flow of purge gas from the adsorber bed to the exhaust line. The valves 70 and 74 are pressure-regulated check valves allowing flow in only one direction, and then only when the pressure differential on opposite sides of the valve reaches a threshold value. Preferably, the valves 70 and 74 have internal spring-actuated poppets for allowing flow in one direction but not in the opposite direction. In short, the “active” valves in the upper portion of the drawing are each selectively controlled by signals from an external source, while the “passive” valves in the lower portion of the drawings operate based on pressure differentials in the system.

To illustrate the operation of the passive valves, the pressure within the on-line third adsorber bed C at time T₀ in FIG. 2a is greater than that in the process conduit 68, and thus gas flows downward through the valve 70c. Valve 70c is “open.” On the other hand, the check valve 74c prevents gas from flowing downward into waste gas conduit 76 at all times, and the pressure differential is such that gas will not flow upward into the pressurized bed C. Valve 74c is “closed.” At the next time frame T₁, shown in FIG. 2b, however, the third adsorber bed C is allowed to depressurize and thus the pressure differential between the bed C and the process conduit 68 reduces such that the check valve 70c closes, preventing gas from the bed from entering the process conduit 68. At the same time, the pressure within the third adsorber bed C remains sufficient to prevent purge gas from the waste conduit 76 from entering the adsorber bed. As the pressure decreases, however, the check valve 74c will eventually open to allow purge gas through the line 72c to purge the third adsorber bed C, as seen in the next time frame T₂.

The liquid oxygen/nitrogen generating system further includes a bypass system of conduits 79 for the three-bed, rapid pressure-swing adsorber 50 shown in FIG. 1, and in the lower portions of FIGS. 2a-2m and FIG. 3. The process conduit 68 and waste gas conduit 76 are connected in a section of conduit 75 between the junctions with the three adsorber beds A, B, C. A pressure-reducing valve 78 and a solenoid-operated valve 80 are positioned in series in the conduit section 75. A check valve 82 is positioned in the waste gas conduit 76 between the adsorber beds A, B, C and the cryogenic distillation process to prevent backflow to the process.

The purge flow to each of the adsorber beds A, B, C may be directly from the waste gas stream produced in the cryogenic distillation process through valve 82 and conduit 76, or may be siphoned off of the filtered or purified process flow from the beds if valve 78 is open. That is, the pressure downstream from the particular bed which is on-line, and thus the pressure in conduit 68 is greater than the waste gas flow pressure in conduit 76, and thus purified process flow from the beds will travel through the open valve 78 into the conduit 76. The purified process flow directly siphoned from the adsorbers is thus available for purging the beds. This siphoned flow from the purified gas stream reduces the total airstream allowed to flow to the cryogenic distillation process, and thus reduces the efficiency of the system. Prior to the waste gas stream reaching a desired level of purification, however, the purge flow must derive from a portion of the process flow. After a certain period of time, the waste stream is of sufficient volume to provide for all the purge flow, and the valve 78 is closed to allow the entire purified gas stream to flow to the cryogenic distillation process, thus maximizing the efficiency of the system.

The operation of each of the adsorber beds during a number of discrete stages of the overall system operation is described with reference to FIGS. 2a-2m, and to the corresponding table in FIG. 5. For illustration purposes, the adsorption cycle is broken up into discrete periods T₀-T₁₂, some of which have a very short duration (indicated to be zero seconds in the chart) and others of which have a much longer duration (such as T₆, which has a duration of 50 seconds). The time periods having a duration of less than one second (T₀, T₄, T₈, and T₁₂), are illustrated to ensure a complete understanding of the system, and are represented as having durations of zero seconds as no significant volume of flow takes place during the time period. The durations of these time periods are given in FIG. 5. In other systems and, if desired, in the preferred systems, these time periods can vary.

Each of the adsorber beds A, B, C may be in one of four operational states, indicated with the symbols in the legend of each of FIGS. 2a-2m. More specifically, the adsorber beds may be “on-line” adsorbing contaminants, “purging” to clean the contaminants, “depressurizing” prior to purging, or repressurizing prior to being on-line.

With reference now to FIG. 2a, a first stage of operation is shown, which is chosen arbitrarily from the cyclical repetition of such stages of operation. In the first stage of operation, indicated as time T₀, feed gas from the filter 22 at high pressure of 30 to 200 psig, and more preferably between 120 and 150 psig, is passed through conduit 52 through inlet selectable valve 56a into adsorber bed A. Feed gas is also passing through inlet leg of three-way valve 54a into common input line 58a and adsorber bed A. Feed gas is purified (or separated) through adsorber bed A and exits via valve 70a and into conduit 68 for delivery to the cryogenic distillation process. The check valve 74a presents flow from the adsorber bed A to the waste gas conduit 76, and prevents flow in the opposite direction due to the higher pressure in the adsorber bed A in comparison with the waste gas conduit 76.

At the same time that adsorber bed A is on-line, the second adsorber bed B is being purged. In this respect, valve 64b is held open and valve 74b is open due to the pressure differential between the waste gas conduit 76 and second adsorber bed B, thus allowing purge flow from the waste gas conduit 76 through bed B to the exhaust conduit 60. Valves 56b, and 70b are closed during this time, as is the input leg of valve 54b. The third adsorber bed C is also on-line at this time, with the valves 56c and 70c open, as well as the input leg of valve 54c.

To transition between the operational states of FIGS. 2a and 2b, the feed gas selectable inlet valve 56c is closed, and outlet valve 70c is caused to close, at third adsorber bed C shut-off time at the start of time period T₁ (FIG. 2b). This momentarily locks feed gas at high pressure in adsorber bed C. The input leg of valve 54c is closed immediately after selectable valve 56c and the output leg of valve 54c opens to begin a controlled, slow depressurization of adsorber bed C by passing the diminishing high-pressure gas into exhaust conduit 60 and out to the atmosphere. The output leg of valve 54c can be configured to allow the adsorber bed C to depressurize at a flow rate such that any nonimmobilized desiccant does not fluidize.

As is well known in the adsorber industry, the superficial velocity of the pressure front in a PSA bed must be below a predetermined value to prevent the desiccant material within the bed C from fluidizing. Typically, the velocity is less than 30 feet per minute (fpm) to avoid such fluidizing, and is usually between 20-30 fpm. Thus, the depressurizing flow rate through the output leg of valve 54c is designed for the particular system architecture to induce a superficial pressure front velocity in bed C of less than 30 fpm. Where immobilized desiccant is used, the velocity can be higher.

During the period T₁, purge gas at essentially atmospheric pressure (0.5 to 5 psig) is fed into waste gas conduit 76 through pressure-reducing valve 78 (if valve 80 is open) from the adsorption process, and/or through valve 82 from the waste stream of the cryogenic distillation process. This purge gas flows through purge gas inlet valve 74b, through second adsorber bed B (in a direction opposite to that which the feed gas flows when the bed is on-line), through valves 64b and 54b, and into exhaust conduit 60 leading to the atmosphere. The depressurizing gas flow is indicated by the arrows 77.

At time T₂, shown in FIG. 2c, valve 64c is opened and 74c opens due to the pressure differential between the waste gas conduit 76 and third adsorber bed C, thus allowing purge gas from waste gas conduit 76 to pass into adsorber bed C. Valves 70b and 70c are closed due to the pressure in outlet process conduit 68 being higher than the pressure in either of the second or third adsorber beds B or C. The valve 64c is opened at a predetermined instant when the pressure in the third adsorber bed C has depressurized to a level sufficient for purging. One of skill in the art will recognize that the time required for slow depressurizing varies based on the geometry of the system and flow parameters, and also that the pressure within the adsorber bed may be sensed and fed back into a control system for actuating the valve 64c. Purge gas then flows from the conduit 76 through the valve 74c and through the third adsorber bed C. During time T₂, the first adsorber bed A remains on-stream purifying or separating the feed gas, and both the second and third adsorber beds B and C are off-stream having the impurities they adsorbed during their on-stream period removed, or desorbed, with purge gas.

At an appropriate time prior to impurities breaking through the outlet side of the first adsorber bed A, the purge outlet valve 64b is closed (at the beginning of time period T₃, FIG. 2d). The term “impurity breakthrough” refers to the condition when the impurity level within the particular on-line adsorber bed is unacceptable, which is typically when the adsorbent material within becomes saturated with impurities to a point at which some may “break through” to the output side. of the bed. It should be noted that the appropriate time prior to impurity breakthrough of the first adsorber bed A is determined empirically, or may be predicted with reasonable certainty from the bed size and flow parameters.

To maximize the efficiency of such a system, the on-line bed can adsorb contaminants up to the point at which it becomes saturated with impurities. Simultaneously, the parallel bed which will next go on-line can be purged for a maximum time period prior to repressurization. Thus, while the first bed is on-line, the purge period of the next bed will be the total on-line period of the first bed, minus the time to slowly repressurize the next bed. In one specific example set forth in more detail below, the on-line bed adsorbs for 90 seconds, and during that period the next bed purges for the first 70 seconds, and repressurizes for the last 20 seconds. This synchronizes the completion of repressurizing of the next bed with the instant of impurity saturation of the first bed, thus maximizing both the purge and on-line times of each, respectively.

After valve 64b is closed, the input leg of valve 54b is opened which allows feed gas from conduit 52 into the second adsorber bed B, as indicated by flow arrows 84. The input leg of valve 54b is configured to allow a controlled, slow repressurization of adsorber bed B. The input leg of valve 54b allows the adsorber bed B to repressurize at a flow rate which, for the particular system architecture, induces a superficial pressure front velocity of less than 30 fpm in bed B to prevent the desiccant material within the bed from fluidizing. However, as noted above, where an immobilized desiccant is used, higher velocities can be used. During this time, valve 74b is closed due to the pressure in adsorber bed B being higher than the pressure in waste gas conduit 76.

At time T₄ (FIG. 2e), when the pressure in the second adsorber bed B is essentially the same as the pressure in the feed gas conduit 52, the selectable valve 56b is opened, putting adsorber B on-line and allowing feed air to be purified or separated by passing through the adsorber bed. In this respect, the purified or separated air downstream of the second adsorber bed B passes through valve 70b and into process conduit 68 for delivery to the subsequent cryogenic distillation process. At this time the first adsorber bed A remains on-line so that the process has an uninterrupted supply and third adsorber bed C continues to be purged.

Shortly after selectable valve 56b is opened to put the second adsorber B on-line, the selectable valve 56a closes at first bed A shut-off time at the start of time period T₅ (FIG. 2f). The input leg of valve 54a is closed immediately after valve 56a and the now open output leg begins a controlled, slow depressurization of the first adsorber bed A by passing the diminishing high-pressure gas into the exhaust conduit 60 and out to the atmosphere (shown by flow arrow 86). During this time, purge gas, at essentially atmospheric pressure (0.5 to 5 psig), is still being fed into waste gas conduit 76 through pressure-reducing valve 78 (if valve 80 is open) and/or valve 82 from the waste gas stream of the cryogenic distillation process. This purge gas flows through valve 74c in a direction opposite to the normal flow of feed gas, through valve 64c and output leg of valve 54c, and into exhaust conduit 60 leading to the atmosphere. During this time, valves 70a and 70c are closed due to the pressure differential between the process conduit 68 and the pressure in the first and third adsorber beds A and C, respectively.

As shown in FIG. 2g, at the beginning of time period T₆, when the adsorber bed A has depressurized to essentially the pressure in the waste gas conduit 76, valve 64a is opened allowing purge gas to pass through valve 74a and through the first adsorber bed A. Purge gas passes from the adsorber bed A through the valve 64a and output leg of valve 54a, into the exhaust conduit 60. During this time the second adsorber B is on-line, purifying or separating the feed gas, and the first and third adsorbers A and C are off-line, having the impurities they adsorbed during their on-line period removed (desorbed) with purge gas.

At an appropriate time prior to impurities breaking through the outlet side of the second adsorber bed B, valve 64c is closed which corresponds to the beginning of time period T₇ (FIG. 2h). The input leg of valve 54c is immediately opened and allows feed gas (indicated at 88) from conduit 52 to flow through the valve 54c into the third adsorber bed C. The input leg of valve 54c is configured to allow a controlled, slow repressurization of adsorber bed C. Valve 74c is held closed by the pressure in the third adsorber bed C being higher than the pressure in the conduit 76.

At a predetermined time corresponding to when the pressure in the third adsorber bed C reaches essentially the same pressure as that in feed gas conduit 52, the selectable valve 56c is opened (time T₈, seen in FIG. 2i). This puts the third adsorber C on-line and allows feed air to be purified or separated by passing through valve 70c and into process conduit 68 for delivery to the cryogenic distillation process. The second adsorber bed B remains on-stream so that the process has an uninterrupted supply of purified feed gas.

As indicated in FIG. 2j, at the start of time period T₉, immediately after selectable valve 56c is opened and puts adsorber C on-line, the selectable valve 56b is closed at bed B shut-off time. The input leg of valve 54b is closed immediately after valve 56b and begins a controlled, slow depressurization of the second adsorber bed B by allowing the high-pressure gas from the adsorber bed to exhaust slowly into conduit 60 and out into the atmosphere (as indicated by flow arrows 90). During this time, purge gas at essentially atmospheric pressure is still being fed into conduit 76 through pressure-reducing valve 78 (if valve 80 is open) and/or valve 82 from the waste stream of the cryogenic distillation process. This purge gas flows through valve 74a, through the first adsorber bed A in a direction opposite to that of the feed gas, through valve 64a and output leg of valve 54a, and into the exhaust conduit 60 leading to the atmosphere. Valves 70a and 70b are held closed by the pressure differential between the process gas conduit 68 and the pressure in the first and second adsorber beds A and B, respectively. That is, the pressure in the process conduit 68 is higher than that in the first or second adsorber beds A or B.

At the beginning of time period T₁₀, shown in FIG. 2k, valve 64b is opened. At this time the pressure in adsorber bed B is essentially the same as that in the waste gas conduit 76. This allows purge gas from conduit 76 to pass through valve 74b, through the second adsorber bed B, through both valve 64b and output leg of valve 54b, into the conduit 60 and out to the atmosphere. During this time period, the third adsorber C remains on-line, purifying or separating feed gas, and the first and second adsorbers A and B are off-line, having the impurities they adsorbed during their on-stream period removed with purge gas.

At a time prior to impurities breaking through the outlet side of the third adsorber bed C, valve 64a is closed at the beginning of time period T₁₁, as shown in FIG. 21. Immediately afterward, the input leg of valve 54a is opened to allow feed gas from conduit 52 to pass therethrough into the first adsorber bed A, as indicated by flow arrows 92, to begin a controlled, slow repressurization of the first adsorber bed. During this time, valve 74a is closed due to the higher pressure in the first adsorber bed A in comparison to the pressure in the waste gas conduit 82.

At a predetermined time T₁₂ corresponding to when the pressure in the first adsorber bed A is essentially the same as the pressure in the feed gas conduit 52, selectable valve 56a is opened, as seen in FIG. 2m. This puts the first adsorber A on-line and allows feed gas to be purified or separated by passing therethrough past valve 70a and into the process conduit 68 for delivery to the cryogenic distillation process. The third adsorber C remains on-line so that the process has an uninterrupted supply of purified gas.

It is to be noted that the operational state illustrated in FIG. 2m at time T₁₂ is the same as the operational state of FIG. 2a at time T₀. Thus, the entire cycle is shown through FIGS. 2a-2m, which cycle is repeated for a continuous process.

With reference to FIG. 3, a microprocessor 100 is illustrated connected to a plurality of control elements for selecting the operational states of the “active” valves 54, 56 and 64. More particularly, the microprocessor 100 controls three solenoid valves 102a, 102b, 102c, which, respectively, control the open or closed state of each of the purge exhaust valves 64a, 64b, 64c, of the three adsorber beds A, B, C. Likewise, the operational state of the three main feed gas input valves 56a, 56b, 56c, is selectable by the action of three solenoids 104a, 104b, 104c, connected to the microprocessor 100. Finally, the microprocessor 100 is connected to three solenoid-actuated pilot valves 106a, 106b, and 106c for controlling one of the three-way valves 54a, 54b, 54c. That is, the pilot valves 106 control a piston within the respective three-way valves 54 and function as toggle switches to allow flow either out of the output leg of the three-way valve, or into the input leg, depending on the position of the piston. As indicated above, these operational states are shown in FIGS. 2a-m for each of the three-way valves 54. By controlling the valves 54, 56 and 64, the adsorption process is optimized to enable the volumetric flow of feed gas to be increased while the volumetric flow of waste gas siphoned off in the adsorption process to purge each of the adsorber beds is decreased.

A typical sequence of operation of each of the valves is indicated in table form in FIG. 4. Along the top row, each of the valves is indicated, as well as its function and designated microprocessor output number. Therefore, there are nine outputs from the microprocessor leading to the nine valves. The function of each of the valves is indicated by the letter designation of the respective adsorber bed (A-C), and by the initial of the particular flow through that valve. Feed gas inlet valves 56 are thus designated with a capital I. Purge gas exhaust valves 64 are designed with a capital E. Each three-way valves 54 has two legs: an input leg for repressurizing (R) adsorber bed, and an output leg for dumping or depressurizing (D) the adsorber bed. The table of FIG. 4 shows a number of discrete steps in the microprocessor control algorithm for which actions are taken. At each step, the operation condition of each valve (or leg) is indicated with an O (open) or an X (closed). The specific action taken at each step is shown in bold for clarity.

Step 0 corresponds to an initial condition, or to the condition in step 18 during the adsorption process. Therefore, if the process has cycled at least once, the action taken in step 0 (or 18) is to change the condition of selectable valve 56a from closed to open. This opens the input of feed gas into the first adsorber bed A. In step 2, the selectable valve 56c which controls the feed gas input to the third adsorber bed C is closed from an open state. The elapsed time between step 0 and step 1 is 0.6 seconds. In step 2, after another 0.6 seconds, the three-way valve 54c is switched from a condition allowing feed gas into the third adsorber bed C, to a condition in which purge gas is allowed out of the third adsorber bed. This is indicated by the closed condition of C-R, and the open condition of C-D. In step 3, which is 20 seconds after the initial time 0, the exhaust valve 64c of the third adsorber bed C is opened. This allows the third adsorber bed to begin purging. After another 50 seconds at step 4, the exhaust valve 64b of the second adsorber bed B is closed. This halts the purging of the second adsorber bed B. In step 5, after another 0.6 seconds, the three-way valve 54b is switched from a condition allowing gas to flow from the second adsorber bed, to a condition allowing gas to flow into the adsorber bed from the feed gas conduit 52. After approximately 20 more seconds, the selectable feed gas inlet valve 56b to the second adsorber bed B is opened. As is apparent from the table, the adsorption process continues with a similar sequence of valve openings and closings for the entire cycle, until at step 18 the cycle repeats.

FIG. 5 illustrates the time periods T₀-T₁₂ and the operational states of each of the adsorber beds A, B, C. The duration of each of the intervals is also given in this chart. Thus, it can be seen that, for example, during times T₁-T₃, bed A is on-line for 90 seconds. Likewise, during the time intervals T₅-T₇ and T₁₀-T₁₂, the beds B and C are on-line, respectively, for 90 seconds each. The time between one bed being on-line for 90 seconds and another bed being on-line for 90 seconds is relatively short. Therefore, at times T₄ and T₈, both of the adsorber beds A and B are on-line for a short period of time during the transition from A to B. Likewise at time T₈, both of the beds B and C are on-line during the transition from the on-line 90 seconds of the bed B to the on-line 90 seconds of the bed C.

In addition, each of the beds are purged for a length of time greater than its on-line time. Therefore, for example, bed A is purged between times T₆ and T₁₀, for a total of 140 seconds. The same applies to the second and third adsorber beds B and C. To accomplish this, two beds are purged purged at the same time. For example, at time T₂, beds B and C are both being purged for 50 seconds. Likewise, at times T₆ and T₁₀, two beds are being purged at the same time for 50 seconds each. This arrangement greatly increases the efficiency of the system and allows for reduced size of the physical components.

It is preferable that the valve frequency be controlled automatically, since the operational times for the valves in each sequence can be from fractions of a second up to three minutes, making it very difficult to control manually. Indeed, the valves are preferably controlled by a central processing unit (CPU) with instructions from a user input. The particular CPU is not critical, and desirably an off-the-shelf programmable logic controller is used, the specific timing sequences being input via an EPROM chip.

The preferred control method involves calculating the specific intervals in which the three adsorber beds are on-line, purging, repressurizing and depressurizing. These intervals may be determined from an analysis of the system size and flow parameters, or from empirical testing of a particular system or scale prototype. The knowledge of the specific intervals allows easy and trouble-free operation or programming of the control sequence, and monitoring of the operation of the system can identify areas in which the sequence is less than optimal, thus prompting a revision to the sequence. Alternatively, however, a system of sensors place in strategic locations in and around the adsorber beds may be used to provide feedback for dynamically controlling the adsorption process. For example, the level of impurities may be detected by a sensor placed near the output end of each bed to determined when that bed has reached capacity and must be purged. Likewise, a pressure sensor may be placed in each bed to sense when the steps of repressurizing and depressurizing are complete. In sum, one of skill in the art will recognize that although a fixed interval sequence is described and shown herein, other more elaborate control systems may be implemented.

Further increasing the efficiency of the system, if the purge gas is derived from the waste gas stream of the cryogenic distillation process, valve 78 can be closed when the process is near full operation, further conserving feed gas flow and reducing the horsepower requirements of the total system.

The following specific example illustrates the improved efficiency of the present system. It is determined that the desired purge factor is 2 (purge gas volume to feed gas volume) for satisfactory purging of the adsorber beds and that it requires 20 seconds each to depressurize and repressurize the adsorber beds without damage to the nonimmobilized adsorbent material within. The nonimmobilized beds are much less expensive and are easier to replace than immobilized beds, and also lend themselves to partial replacement in the field. Of course, where immobilized adsorbent material is used, depressurizing and repressurizing the adsorber bed can be accomplished more quickly.

The following process conditions prevail:

| Process pressure | P₁ = | 140 psig |
|---|---|---|
| Purge pressure | P₂ = | 2 psig |
| Atmospheric pressure | Pₐₜₘ = | 14.7 psig |
| Feed gas flow rate | Q_{f,atm} = | 600 scfm (cubic feet per |
| | | minute at standard |
| | | atmospheric conditions) |
| Purge Factor | PF = | 2 |

The volumetric flow rate Q₁ for the on-stream adsorber bed is:
Q_{f}=(Q_{f,atm}×Pₐₜₘ)/(P₁+Pₐₜₘ), or
(600×14.7)/(140+14.7)=57 cubic feet per minute (cfm)

If the adsorber beds have an on-stream time of 90 s (1.5 min), the total volume of feed gas Vol_{f} during the on-stream period is:
Vol_{f}=t×Q₁, or
1.5×57=85.5 cubic feet

The purge gas volume Volₚ required is:
Volₚ=PF×Vol_{f}, or
2×85.5=171 cubic feet, where
PF (Purge Factor)=2
Two-Bed PSAs

The purge time is tₚ available for 2 bed PSA is:
90−20−20=50 s

To get 171 cubic feet of purge gas at 2 psig in a 50-second period requires:
Q_{p,atm}=(Volₚ/tₚ)×(P₂+Pₐₜₘ)/Pₐₜₘ, or
171/(50/60)×(14.7+2)/14.7=233 scfm

The net flow rate available for the process is:
Qₙₑₜ=Q_{f,atm}−Q_{p,atm}, or
600−233=367 scfm

If the waste gas stream from the cryogenic distillation process were used, the process could only utilize 367 scfm for the final product, an efficiency of 61%.

Three-Bed PSAs

In contrast, the purge time tₚ available for the three-bed system is
2×90−20−20=140 seconds

During this 140-second period, the purge gas will be going through two adsorber beds in parallel for 50 seconds (t₁) and through one bed alone for 40 seconds (t₂). To get 171 cubic feet of purge gas at 2 psig in this 140-second period requires:
Q_{f,atm}=(Volₚ/tₚ)×(P₂+Pₐₜₘ)/Pₐₜₘ, or
171×(60/140)×(14.7+2)/14.7=83.3 scfm average flow rate

Since only half of the actual flow rate passes through a bed for 100 seconds of the total 140-second purge period, the actual purge gas flow rate required is:
Q_{req}=(Q_{avg}×tₚ)/(0.5×t1+t2)
(83.3×140)/(0.5×100+40)=130 scfm

The net flow rate available for the cryogenic distillation process is:
Qₙₑₜ=Q_{f,atm}−Q_{p,atm}, or
600−130=470 scfm

If the waste gas stream from the cryogenic distillation process were used, the process could use 470 scfm for the final product, an efficiency of 78%. The improvement realized by utilizing the three-bed pressure-swing adsorber system is 28%; the process efficiency is improved from 61% to 78%.

Longer Two-Bed Systems

If the two-bed pressure-swing adsorber system were to have an on-stream time of 15 minutes, the feed gas volume Vol_{f} required would be:
Vol_{f}=Q_{f}×t
57×15=855 cubic feet

The purge volume would be:
Volₚ=PF×V_{olf}, or
2×855=1710 cubic feet, where
PF (Purge Factor)=2

The purge time tₚ for this two-bed pressure-swing adsorber system would be
15−(40/60)=14⅓ minutes

To get 1710 cubic feet of purge gas at 2 psig in 14⅓ (43/3) minutes requires:
Q_{p,atm}=(Volₚ/tₚ)×(P₂+Pₐₜₘ)/Pₐₜₘ, or
1710(3/43)×(2+14.7)/14.7=135.5 scfm

This is still less than the three-bed pressure-swing adsorber. To extend the on-stream time to 15 minutes, the adsorber beds would have to be about 10 times as long as the three-bed pressure-swing adsorber system and about 6.7 times the weight. Also, because of the additional volume of the beds, it would likely require nearly 10 times as long to safely depressurize and repressurize the beds. The additional time has not been accounted for in this analysis. This would further reduce the efficiency gains achieved from longer on-stream times.

The following table graphically illustrates the improved efficiency and other benefits of the present three-bed, nonimmobilized, rapid pressure-swing adsorber 50 versus the short and long two-bed systems.

TABLE 1

| | | | | | Depressurization |
|---|---|---|---|---|---|
| System | Efficiency | Process Time | Bed Size | Pressurization Rate | Rate |
| Preferred | 78% | 90 seconds | 20″ D × 27″ L × 3 | 138 psi in 20 | 138 psi in 20 |
| System | | | | seconds | seconds |
| 2-Bed PSA | 61% | 135 seconds | 20″ D × 27″ L × 2 | 138 psi in 7 | 138 psi in 1 |
| | | | | seconds | second |
| 2-Bed | 77% | 15 minutes | 20″ D × 270″ L × 2 | 138 psi in 70 | 138 psi in 10 |
| Lengthened | | | | seconds | seconds |
| PSA System | | | | | |

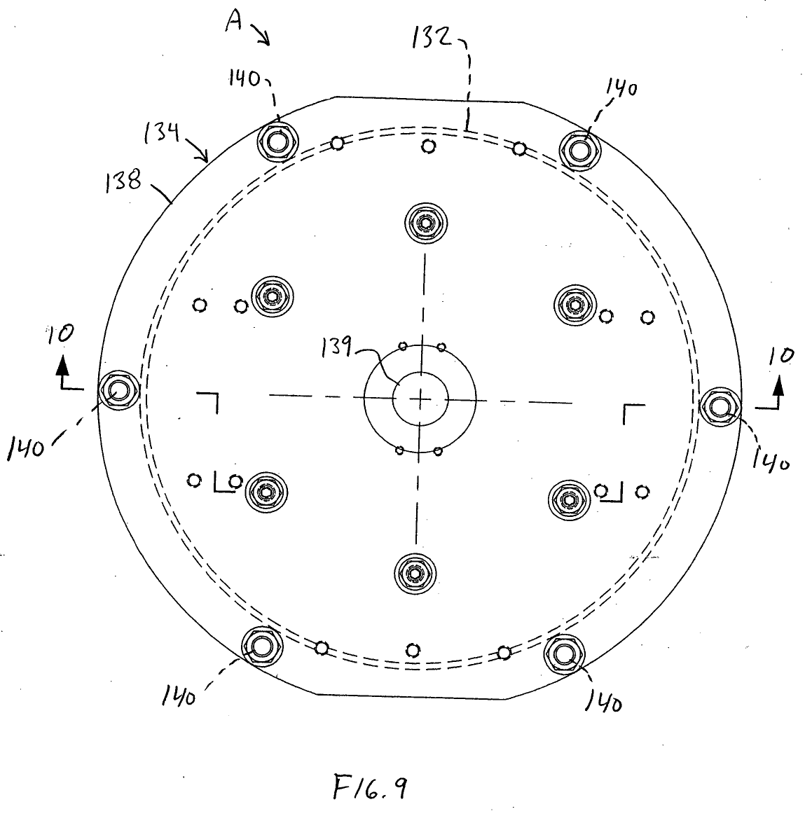

With reference to FIGS. 6-11, an exemplary pressure-swing adsorber unit 24 is illustrated therein to provide further detail as to the environment of use at the present adsorber bed assembly. The components of the pressure-swing adsorber unit 24 illustrated in FIG. 6 includes the same reference numerals used in FIG. 1. Thus, a further description of the components already described above will not be repeated.

With reference to FIG. 6, the filter 22 noted above with reference to FIG. 1, in the illustrated exemplary embodiment, comprises three filters 120, 122, 124. The filter 120 comprises a commercially available water separator filter. The filters 122 and 124 can comprise commercially available high and ultrahigh efficiency filters, respectively. Each of the filters 120, 122, 124 preferably include drain valves 126 to facilitate draining of liquids therefrom.

The filters 120, 122, 124 are connected in series along the feed gas line 52. Additionally, the illustrated pressure-swing adsorber unit 24 includes pressure transducers 128 for monitoring the pressure therein.

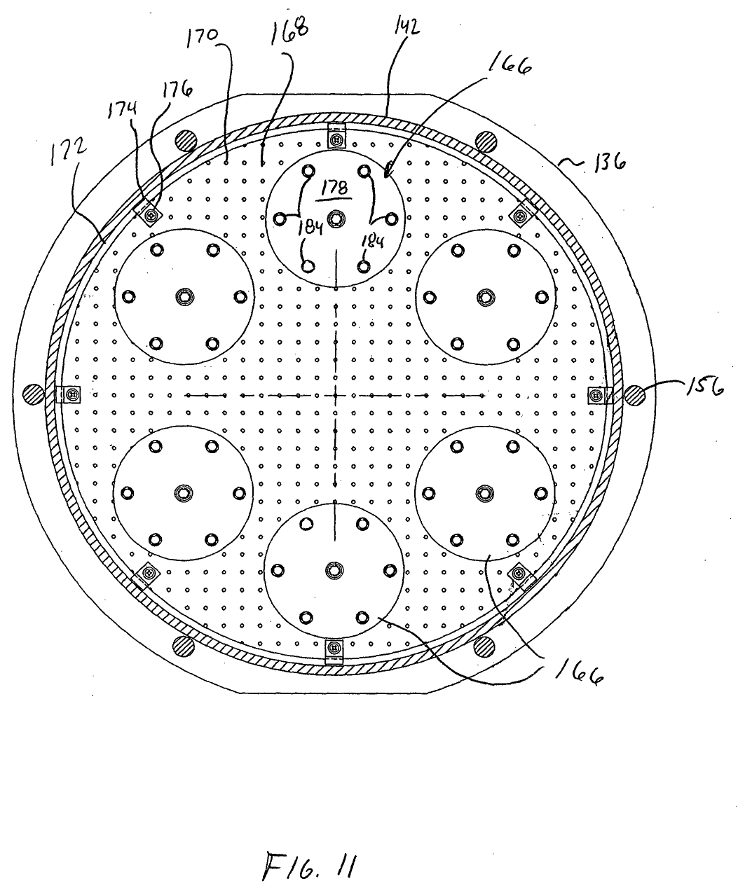

With reference to FIG. 8, each of the adsorber bed assemblies A, B, C includes an adsorber bed housing 130. The housing 130 includes at least one wall member 132 and upper and lower lid members 134, 136.

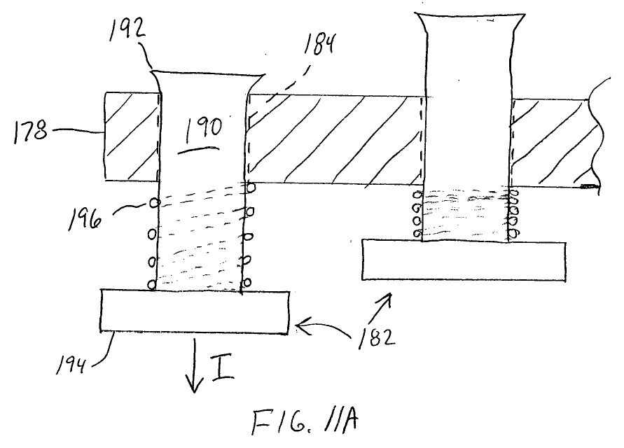

With reference to FIG. 9, the upper lid member assembly 134 comprises a plate member 138 which is configured to sealedly engage the wall assembly 132. In the illustrated embodiment, the plate member 138 is generally circular in shape and includes a plurality of clamping apertures 140 disposed around a periphery thereof. The upper lid assembly 134 includes an inlet aperture 139 configured to receive feed gas from the feed gas pipe 52. The lower lid assembly 136 includes an outlet 141 configured to discharge filtered gas to the discharge pipe 68.

In the illustrated embodiment, the wall assembly 132 comprises a cylinder member 142. The plate member 138 includes a central thickened portion 144 defining an outwardly facing wall 146. The outer diameter of the outer facing wall 146 is sized so as to form tight engagement with an inner surface of the cylinder member 142.

Preferably, the thickened portion 144 also includes an O-ring groove 148 defined in the outer surface 146. The O-ring groove 148 is configured to retain an O-ring 150 to provide an enhanced seal between the outer surface 146 and the inner surface of the cylinder member 142.

The lower lid assembly 136 can be configured similarly or identically as the upper lid assembly 134. The details of the lower lid assembly 136 will not be described further. Rather, the description of the upper lid assembly 134 set forth below also applies to the lower lid assembly 136. Thus, components of the upper lid assembly 134 that correspond to the same or similar components of the lower lid assembly 136 will be identified with the same reference numerals.

Together, the upper lid assembly 134, the lower lid assembly 136, and the wall assembly 132 define an interior chamber 152. The housing 130 preferably includes at least one clamping device configured to apply a clamping force to retain the upper and lower lid assemblies 134, 136 to open ends of the wall assembly 132. In the illustrated embodiment, the housing 130 includes a plurality of tie rods 154 configured to retain the upper and lower lid assemblies 134, 136 to the open ends of the cylinder member 142. In the illustrated embodiment, the tie rod assemblies 154 comprise an elongate rod member 156 with threaded ends 158. The elongate bodies 156 are sized so as to pass through the apertures 140 defined in the upper and lower lid assemblies 134, 136. Nuts 160 are threadedly engaged with the ends 158 so as to apply a clamping force to the upper and lower lid assemblies 134, 136 so as to retain the assemblies 134, 136 to the open ends of the cylinder member 142.

The housing 130 also includes a compression assembly 162. The compression assembly 162 comprises a screen member 164 and spring units 166.

FIG. 11 illustrates a top plan view of the screen assembly 164. As shown in FIG. 11, the screen assembly comprises a perforated screen member 168 that is sized having an outer diameter approximately equal to that of the inner diameter of the cylinder member 142. The screen member 168 can be made from a thin rigid material having a plurality of holes 170 disposed therein. The holes 170 are sized so as to be smaller than the beads forming the adsorbent material disposed within the chamber 152, described in greater detail below.

The screen assembly 164 also comprises a seal member 172 extending around the periphery thereof. In the illustrated embodiment, the seal member 172 is a ring seal configured to form a tight fit or an interference fit with the inner surface of the cylinder member 142. A plurality of clips 174 are disposed around the periphery of the screen member 168 and are configured to retain the ring seal 172 against the screen member 168 and the inner surface of the cylinder member 142. In the illustrated embodiment, the clips 174 secured to the screen member 168 with screws 176. Of course, other types of fastening arrangements can be used.

With reference again to FIG. 10, the compression assemblies 166 include a carrier member 178, a loading member assembly 180 and a plurality of pressing members 182. As shown in FIG. 11, the carrier members 178 are generally disk shaped and include a plurality of mounting apertures 184 configured to receive the pressing members 182.

FIG. 11a illustrates a partial sectional view of a portion of one of the carrier plates 178 and including two pressing members 182, one being illustrated in an extended position and one illustrated in a retracted position. Each of the pressing member assemblies comprises a body member 190 extending through the aperture 184. An outer end 192 of the body member 190 is enlarged to a size greater than that of the aperture 184. An inner end of the body member 190 includes a pressing portion 194 which is also enlarged to a size greater than that of the aperture 184. Thus, the body member 190 is retained within the aperture 184.

Additionally, the pressing member assemblies include a biasing member 196 configured to bias the body member toward an inward direction, in the direction of arrow I. The biasing member can be any type of device that can be configured to provide a biasing force. In the illustrated embodiment, the biasing member 196 is a coil spring.

With reference again to FIG. 10, the loading member assembly 180 is configured to adjust a position as a carrier member 178 relative to the plate member 138 of the upper lid assembly 134. In the illustrated embodiment, the loading member assembly 180 is comprised of a bolt 200 and a set of nuts 202, 204 for fixing the position of the bolt 200 relative to the plate 138. The bolt extends through a threaded aperture defined in the plate 138.

When adjusted inwardly the bolt 200 acts against the retainer member 178 so as to move the carrier member 178 inwardly toward the chamber 152. During installation, when the bolt 200 is turned to the desired position, the nut 204 is tightened so as to fix the rotational position of the bolt, thereby fixing the position of the carrier plate 178. Additionally, the nut 202 is used to compress a sealing member 203 against the upper surface of the plate 138, thereby sealing the aperture through which the bolt 200 extends.

The arrangement of the pressing members 182 about the carrier member 178 acts to distribute the load more evenly about the screen member 168. Additionally, the biasing members 196 act to distribute the load evenly despite irregularities in the shape of the screen member 168.

As shown in FIG. 11, a plurality of compression assemblies 166 are arranged around the screen member 168. Additionally, a similar or identical arrangement of compression assemblies 166 are provided at the lower end of the housing 130 and mounted relative to the lower lid assembly 136.

The screen members 168 cooperate with the inner surface of the cylinder member 142 to define a chamber for retaining adsorbent beads therein, under compression. When the adsorbent beads within the chamber are not immobilized, a variety of sizes of beads preferably is used therein. For example, with reference to FIG. 10, layers of larger beads 210 are disposed adjacent the screen members 168. An intermediate layer of beads 212 can be disposed inwardly from the outer layers 210. Additionally, an inner layer of beads 214 can be disposed between the intermediate layers 212.

In one exemplary, but nonlimiting embodiment, the layer of beads 210 can comprise alumna-activated Grade A adsorbent beads having a diameter of approximately 0.188 inches. Such beads are commercially available from Alcoa, Inc. The intermediate layers of beads 212, in the exemplary embodiment, are available from Davidson, Inc. as molecular sieve material type 13×8½. Further, the inner layer beads 214 can comprise alumna-activated beads having a diameter of about 0.060-0.098 inches (Grade A) commercially available from Alcoa, Inc. Where the layers of beads 210, 212, 214 are nonimmobilized, the depressurization and repressurization of the chamber 152 within the adsorber bed A preferably is carried out slowly so as to minimize shocks imparted to the beads of the layers 210, 212, 214.

After prolonged use, despite attempts to minimize shock and abrasion, the beads of the layers 210, 212, and/or 214 can degrade. When the beads degrade, they can generate dust and particles which flow out of the housing 130 and into the downstream components of the system. Thus, the beads must periodically be replaced.

In order to replace the beads, within the housing 130, the housing 130 must be disassembled, emptied of the beads, and cleaned. After the housing 130 has been cleaned, the layers of beads 210, 212, 214 can be replaced and housing 130 reassembled. With the design illustrated in FIG. 10, it takes a worker approximately one week to disassemble, clean, refill, and reassemble the adsorber beds, such as the adsorber beds A, B, C.

Because the layers of beads 210, 212, 214 are not immobilized, the replacement of the layers of beads 210, 212, 214 can be performed on site. An immobilization process such as that referred to above as being owned by Pall Safety Atmospheres, Inc. would require the entire housing 130 to be sent to a facility appropriate for performing the proprietary process of being filled with adsorbent beads, coated with an immobilizing agent, and cured. Due to the potential transportation cost and time required therefore, refilling the housing 130 immobilized beads can be far more expensive than refilling the housing 130 with non-immobilized beads.

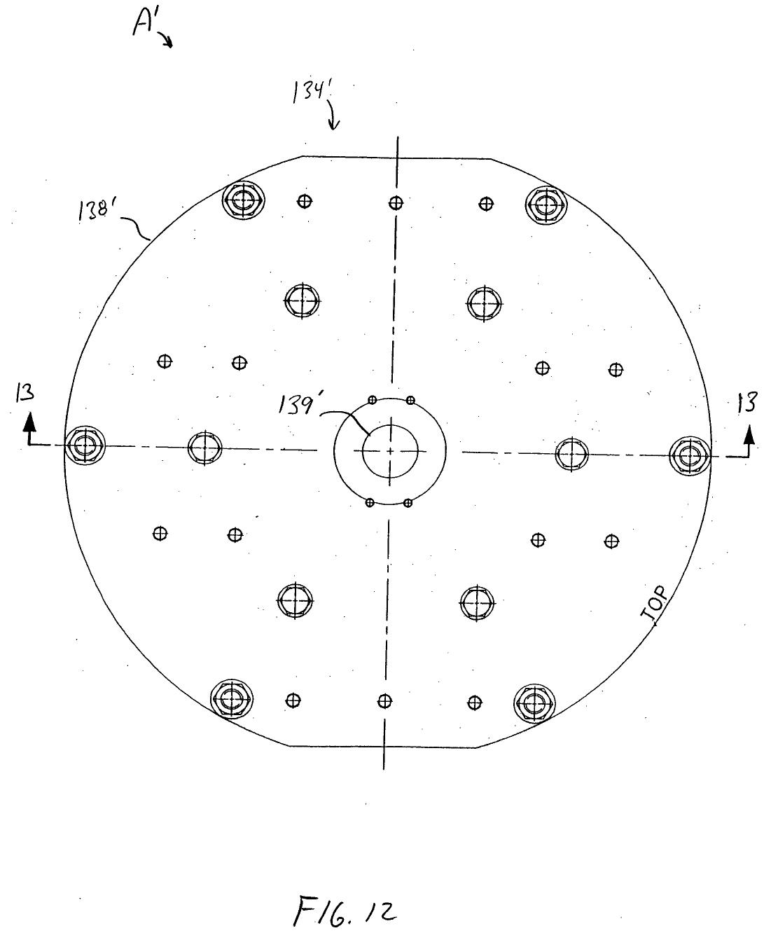

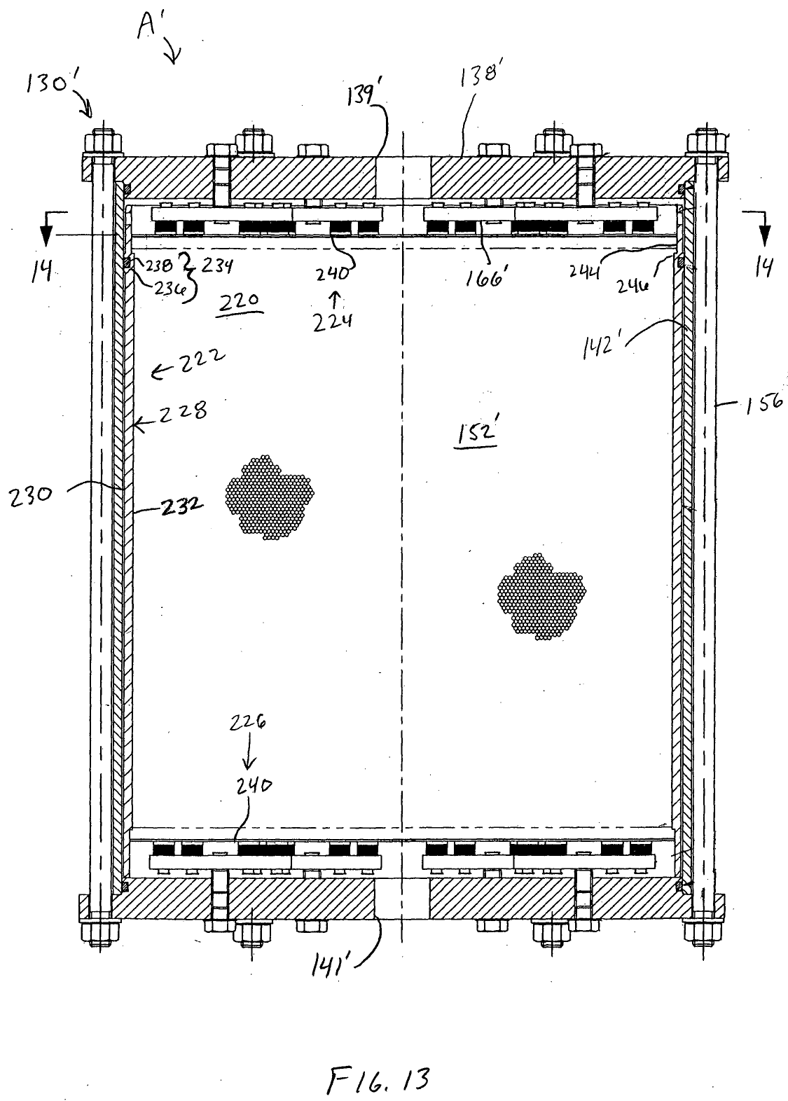

FIGS. 12-16 illustrate an improved adsorber bed, identified generally by the reference numeral A′. A components of the adsorber bed A′ that are the same or similar to the adsorber bed A are identified with the same reference numerals, except that a “′” has been added thereto.

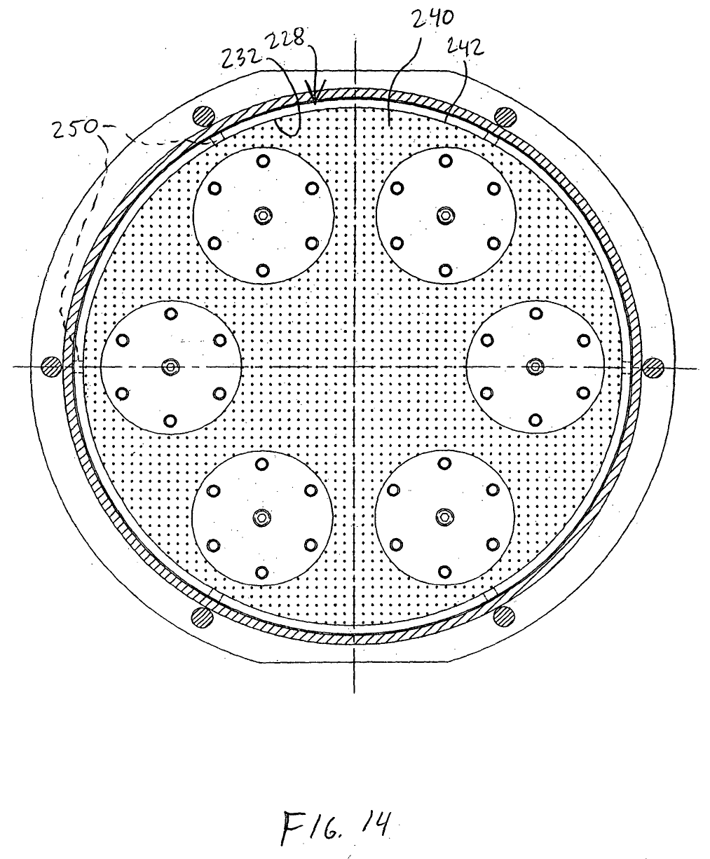

As shown in FIG. 12, the upper lid assembly 134′ of the adsorber bed assembly A′ can include a plate member 138′ that can be similar or essentially identical to the plate 138. As shown in FIG. 13, the adsorber bed assembly A′ includes a removable cartridge assembly 220. The cartridge assembly 220 includes a wall assembly 222 and upper and lower screen assemblies 224, 226.

The wall assembly 222 can comprise a cylinder member 228 having an outer surface 230 and an inner surface 232. The outer surface 230 of the cylinder member 228 can define an outer diameter that is configured to form a tight fit with the inner surface of the cylinder member 142′. As such, a flow of feed gas entering the inlet 139′ is directed through the interior chamber 152′ and is prevented from flowing between the outer surface 230 of the cylinder member 228 in the inner surface of the cylinder member 142′.

Preferably, the outer surface 230 of the cylinder member 228 includes a sealing assembly 234. The sealing assembly 234 advantageously is configured to enhance a seal between the outer surface 230 and the inner surface of the cylinder member 142′.

In the illustrated embodiment, the seal assembly 234 comprises an O-ring groove 236 defined on the outer surface 230 and an O-ring 238 disposed in the O-ring groove 236 and configured form a seal against the inner surface of the cylinder member 142′. The size and type of the O-ring 238 can be determined by one of ordinary skill in the art. Further, it is to be noted that it is not necessary for the seal assembly 234 to withstand the pressure differential between the interior chamber 152′ and the atmosphere during operation. Rather, the seal assembly 234 can be configured merely to withstand the pressure differential or “head loss” generated by the flow of feed gas from the inlet 139′ to the outlet 141′. Additionally, one of ordinary skill in the art should note that because the cylinder member 142′ will be subject to the pressure differential generated by the pressure of feed gas within the interior chamber 152′ and the atmosphere outside of the cylinder member 142′. As such, the sidewalls of the cylinder member 142′ can deflect outwardly. Thus, the seal assembly 234′ should be constructed in light of this potential outward deflection.

Because the wall assembly 222 is not subject to the full pressure differential, during operation, between the interior chamber 152′ and the atmosphere outside of the cylinder member 142′, the wall assembly 222 can be constructed in a lighter strength configuration than that of the cylinder member 142′. For example, the cylinder member 228 can be constructed to withstand a pressure of, for example, but without limitation, no more than about 100 psig. As such, the cost and weight of the removable cartridge assembly 220 can be lowered. Reducing the weight of the removable cartridge assembly 220 further simplifies removal and installation of the removable cartridge assembly 220.

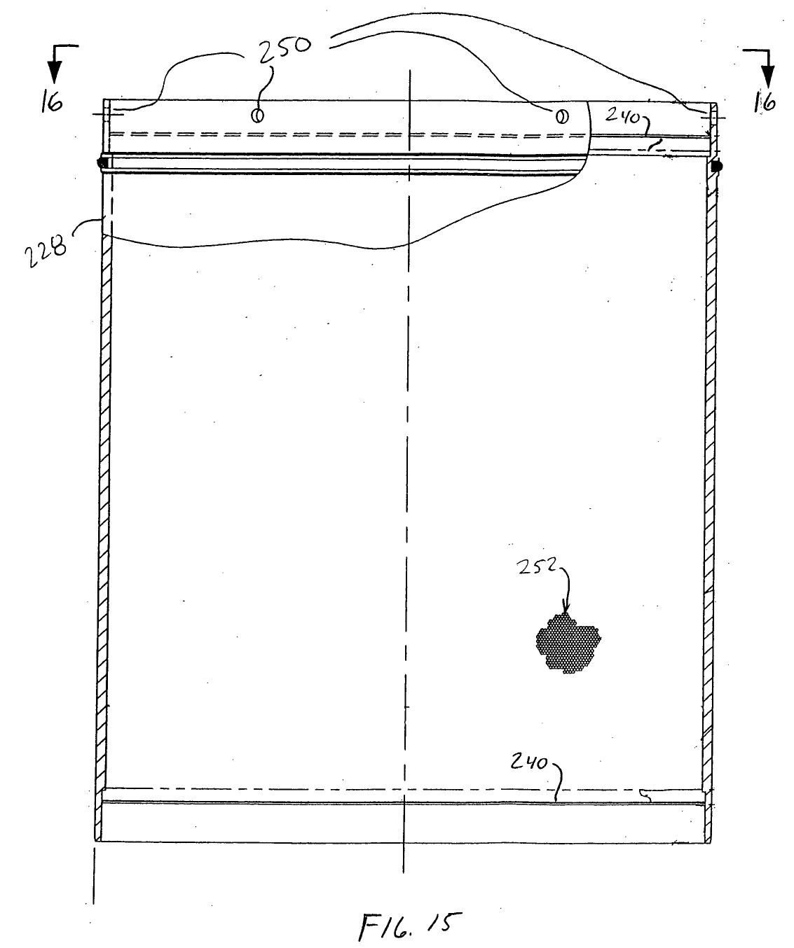

The screen assemblies 224, 226 can each comprise a screen member 240. With reference to FIG. 14, the screen member 240 can be constructed in the same manner as the screen member 168. The outer peripheral edge 242 of the screen member 240 can define a diameter that forms a tight fit with the inner surface 232 of the cylinder member 228. Thus, adsorbent material disposed within the interior chamber 152′ is contained therein by the screen member 240.

With reference again to FIG. 13, the open ends of the cylinder member 228 can define recessed portions 244. The inner surface of the recessed portion 244 can define an inner diameter that is larger than the diameter of the inner surface 232. The transition between the inner surface 228 and the recessed portion 244 can thus define a step 246.

Preferably, the outer peripheral edge 242 of the screen member 240 forms a tight fitting engagement with the recessed portion 244. Further, the outer peripheral edge 244 preferably defines an outer diameter that is larger than the inner diameter of the inner surface 232. As such, the step 246 can define a stop for the screen member 240.

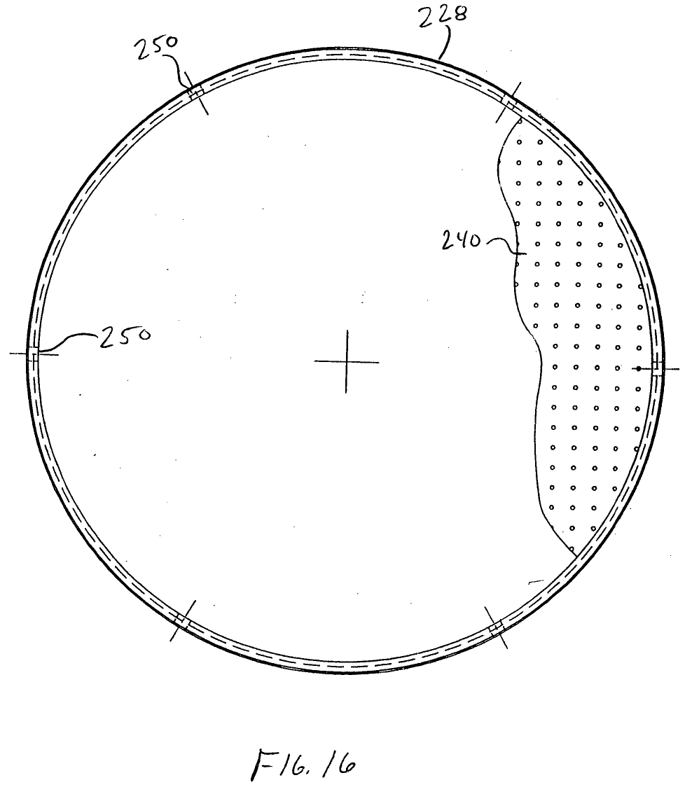

With reference to FIG. 15, at least one of the upper and lower ends of the cylinder member 228 includes at least one aperture 250 extending therethrough. As such, the apertures 250 can facilitate lifting and movement of the cylinder member 228. Preferably, the cylinder member 228 includes a plurality of apertures 250 disposed around an upper periphery thereof. The apertures 250 can be used as hoist points for installing and removing the cylinder member 228 from the interior of the housing 130′.

In the illustrated embodiment, the cylinder member 228 includes one type of adsorbent bead material 252. For example, the adsorbent material 252 can be a small diameter adsorbent bead. Where only one size bead is used, the beads preferably have a smaller diameter, thereby providing a higher surface area to volume ratio and thus a high rate of adsorbency. In the adsorber bed A illustrated in FIG. 10, three different sizes of adsorbent beads were used. For example, the uppermost and lowermost layers 210 of the beads will have a larger diameter than the innermost layer of beads 214 so as to aide in preventing the smallest beads from passing through the screen members 168. Thus, where only one size of small adsorbent beads are used, as schematically illustrated in FIG. 15, the adsorbent material 252 preferably is immobilized with the process such as that noted above as being owned by Pall Safety Atmospheres, Inc.

The removable cartridge 200 provides a low cost and low weight vessel for transporting and storing adsorbent, absorbent, or other materials, in a ready-to-use state. For example, one or a plurality of cylinder members 228 with screen members 240 can be transported to a facility for filling and processing with an immobilizing agent. Thereafter, with the screen members 240 installed on the open ends of the cylinder member 228, the filled and immobilized assembly can be shipped to the location of a user of the pressure-swing adsorber unit 24 utilizing the adsorber bed A′ illustrated in FIGS. 12-14. Thereafter, a user or technician can quickly remove one used cartridge 200 from the housing 130′ and replace it with a new cartridge 200 containing mobilized or immobilized material. This greatly reduces the time required for exchanging adsorbent material out of an adsorber bed. Thus, a user of such a pressure-swing adsorber unit 24 can achieve the benefits of faster depressurization and repressurization rates appropriate for immobilized adsorber material systems and the reduced time required for replacing used adsorber material. Thus, such a user can achieve substantial cost savings and increased productivity.

Although the present invention has been described in terms of a certain embodiment, other embodiments apparent to those of ordinary skill in the art also are within the scope of this invention. Thus, various changes and modifications may be made without departing from the spirit and scope of the invention. For instance, various components may be repositioned as desired. Moreover, not all of the features, aspects and advantages are necessarily required to practice the present invention. Accordingly, the scope of the present invention is intended to be defined only by the claims that follow.

1. A pressure swing absorber unit comprising a housing defining an interior chamber, a removable cartridge assembly removably disposed in the interior chamber, the removable cartridge assembly comprising a wall assembly defining an absorber chamber, inlet and outlet screen members, and an absorber material disposed in the wall assembly, the inlet and outlet screen members being configured to retain the absorber material within the absorber chamber.

2. The pressure swing absorber unit according to claim 1, wherein the housing comprises a first cylinder, the wall assembly of the removable cartridge comprising a second cylinder disposed coaxially in the first cylinder.

3. The pressure swing absorber unit according to claim 2, wherein the first cylinder is configured to withstand a pressure of at least about 140 psig, the second cylinder being configured to withstand a pressure of no more than 100 psig.

4. The pressure swing absorber unit according to claim 1, wherein the removable cartridge assembly further includes hoist points at an upper end thereof.

5. The pressure swing absorber unit according to claim 1, wherein the absorber material comprises a plurality of beads.

6. The pressure swing absorber unit according to claim 1, wherein the removable cartridge assembly comprises a seal disposed on an outer surface thereof configured to form a seal between an outer surface of the removable cartridge and an inner surface of the housing.

7. A removable adsorbent bed cartridge for a swing type adsorber system comprising a wall assembly defining an open inlet and an open the outlet, a plurality of adsorbent members disposed in the wall assembly, a first perforated member disposed at the inlet end and a second perforated member disposed at the outlet end, the first and second perforated members being configured to retain the adsorbent members therein, the wall assembly being configured to be received within a housing of an adsorber bed assembly of the swing type adsorber system.

8. The cartridge according to claim 7, wherein the cartridge is further configured to form a seal between an outer surface of the wall assembly and an inner surface of the housing, at a location between the inlet and outlet ends of the wall assembly.

9. The cartridge according to claim 7, wherein the seal is provided by an o-ring disposed on an outer surface of the wall assembly.

10. The cartridge according to claim 9, wherein the o-ring is configured to withstand a pressure differential generated by the head loss associated with the adsorbent material during operation of the swing type adsorber system.

11. The cartridge according to claim 7, wherein the wall assembly is cylindrical.

12. The cartridge according to claim 7 additionally, comprising a flange extending from the first open end of the wall assembly and a plurality of apertures disposed in the flange.

13. The cartridge according to claim 12, wherein the apertures in the flange are configured to provide hoist points for the cartridge.

14. The cartridge according to claim 7, wherein the wall assembly is configured to withstand a pressure of no more than about 100 psig.

15. The cartridge according to claim 7, wherein the wall assembly further comprises an inner surface and a recessed area disposed on the inner surface adjacent the inlet end.

16. The cartridge according to claim 15, wherein the first perforated member includes an outer peripheral edge disposed in the recessed area.

17. The cartridge according to claim 16, wherein the peripheral edge defines a diameter that is greater than an inner diameter of a portion of the inner surface adjacent the recessed portion.

18. The cartridge according to claim 17, wherein a step is defined at the inner side of the recessed portion.

19. A removable adsorbent bed cartridge for a swing type adsorber system comprising a wall assembly defining an open inlet and an open the outlet, a plurality of adsorbent members disposed in the wall assembly, a first perforated member disposed at the inlet end and a second perforated member disposed at the outlet end, the first and second perforated members being configured to retain the adsorbent members therein, and means for forming a seal between an outer surface of the wall assembly and an inner surface of a housing of an adsorber bed assembly of the swing type adsorber system.

20. The cartridge according to claim 17 additionally comprising means for allowing the adsorbent material to be mechanically compressed after it is installed in the housing.
